(19) United States
(12) Patent Application Publication
(10) Pub. No.: US 2024/0113772 A1
(43) Pub. Date: Apr. 4, 2024

(54) TECHNIQUES FOR HANDLING SELF-OSCILLATION AT REPEATERS

(71) Applicant: QUALCOMM Incorporated, San Diego, CA (US)

(72) Inventors: Navid ABEDINI, Basking Ridge, NJ (US); Junyi LI, Fairless Hills, PA (US); Juergen CEZANNE, Ocean Township, NJ (US)

(21) Appl. No.: 18/466,682

(22) Filed: Sep. 13, 2023

Related U.S. Application Data
(60) Provisional application No. 63/412,120, filed on Sep. 30, 2022.

(51) Int. Cl. H04B 7/155; H04W 24/08

(52) U.S. Cl. CPC H04B 7/1555; H04W 24/08

(57) ABSTRACT

Methods, systems, and devices for wireless communications are described. A repeater device may transmit, to a first network node, a first control message indicating capability information indicative of one or more capabilities of the repeater device and polarization measurement information at the repeater device. The repeater device may receive, from the first network node, a second control message indicating one or more polarization parameters based on the capability information and the polarization measurement information. The repeater device may relay signaling to a second network node based on the one or more polarization parameters.

### CROSS REFERENCE

The present application for patent claims the benefit of U.S. Provisional Patent Application No. 63/412,120 by ABEDINI et al., entitled “TECHNIQUES FOR HANDLING SELF-OSCILLATION AT REPEATERS,” filed Sep. 30, 2022, assigned to the assignee hereof and expressly incorporated by reference herein in its entirety.

### INTRODUCTION

The following relates to wireless communications, including handling self-oscillation at repeaters.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for handling self-oscillation at repeaters. For example, the described techniques provide for a repeater device to use orthogonal polarizations of antenna panels when forwarding signaling to mitigate interference. In some aspects, a time domain duplexing (TDD) repeater device may be configured to apply orthogonal polarizations for transmission and reception to reduce interference and clutter echo. For example, the TDD repeater may be configured to use vertical polarization antenna panels for reception and horizontal polarization for transmission. Additionally, or alternatively, a bidirectional repeater may be configured to apply orthogonal polarizations for relaying in different directions. For example, the TDD repeater may use antenna panels with a vertical polarization to relay uplink signaling and use antenna panels with a horizontal polarization to relay downlink signaling. In some aspects, the repeater device may indicate a capability of supporting orthogonal polarization configurations to a network entity and indicate a measurement of channels or interference at the repeater device. For example, the repeater device may indicate a measurement of clutter echo or self-interference. The network entity may configure the repeater device with a set of one or more polarization parameters for relaying signaling between two network nodes, and the repeater device may relay signaling between the network nodes based on the indicated set of one or more polarization parameters.

In some aspects, the repeater device may perform the measurements and select the set of one or more polarization parameters (e.g., autonomously). The repeater may measure a clutter echo at antenna panels of the repeater device, detect that the clutter echo is affecting reception at the repeater device, and select polarization parameters to apply orthogonal polarizations for transmission and reception (e.g., as a TDD repeater) or different directions (e.g., as a bidirectional repeater). In some aspects, the repeater device may select the polarization parameters based on a configuration received from a control entity (e.g., a UE or network entity). For example, the repeater device may select the polarization parameters based on indicated thresholds for the measurements, resources supported for autonomous parameter selection, or from a set of supported polarization configurations.

A method for wireless communications at a repeater device is described. The method may include transmitting, to a first network node, a first control message indicating capability information indicative of one or more capabilities of the repeater device and polarization measurement information at the repeater device, receiving, from the first network node, a second control message indicating one or more polarization parameters based on the capability information and the polarization measurement information, and relaying signaling to a second network node based on the one or more polarization parameters.

A repeater device for wireless communications is described. The repeater device may include a memory and at least one processor coupled to the memory. The at least one processor may be configured to transmit, to a first network node, a first control message indicating capability information indicative of one or more capabilities of the repeater device and polarization measurement information at the repeater device, receive, from the first network node, a second control message indicating one or more polarization parameters based on the capability information and the polarization measurement information, and relay signaling to a second network node based on the one or more polarization parameters.

Another apparatus for wireless communications at a repeater device is described. The apparatus may include means for transmitting, to a first network node, a first control message indicating capability information indicative of one or more capabilities of the repeater device and polarization measurement information at the repeater device, means for receiving, from the first network node, a second control message indicating one or more polarization parameters based on the capability information and the polarization measurement information, and means for relaying signaling to a second network node based on the one or more polarization parameters.

A non-transitory computer-readable medium having code for wireless communications stored thereon is described. The code may be executable by a repeater device to cause the repeater device to transmit, to a first network node, a first control message indicating capability information indicative of one or more capabilities of the repeater device and polarization measurement information at the repeater device, receive, from the first network node, a second control message indicating one or more polarization parameters based on the capability information and the polarization measurement information, and relay signaling to a second network node based on the one or more polarization parameters.

In some examples of the method, apparatuses, and non-transitory computer-readable medium described herein, the one or more polarization parameters indicate a first polarization for receiving the signaling and a second polarization for transmitting the signaling.

In some examples of the method, apparatuses, and non-transitory computer-readable medium described herein, relaying the signaling may include operations, features, means, or instructions for receiving the signaling using the first polarization based on the second control message and transmitting, to the second network node, the signaling using the second polarization based on the second control message.

In some examples of the method, apparatuses, and non-transitory computer-readable medium described herein, the one or more polarization parameters indicate a first polarization for a first direction and a second polarization for a second direction.

In some examples of the method, apparatuses, and non-transitory computer-readable medium described herein, relaying the signaling may include operations, features, means, or instructions for receiving a first message in the first direction using the first polarization, transmitting the first message in the first direction to the second network node using the first polarization, receiving a second message from the second network node in the second direction using the second polarization, and transmitting the second message in the second direction using the second polarization.

In some examples of the method, apparatuses, and non-transitory computer-readable medium described herein, the one or more polarization parameters include a first set of polarization parameters for a first set of time and frequency resources and a second set of polarization parameters for a second set of time and frequency resources.

In some examples of the method, apparatuses, and non-transitory computer-readable medium described herein, the first set of time and frequency resources includes a first passband, a first subband, or a first set of resource blocks, and the second set of time and frequency resources includes a second passband, a second subband, or a second set of resource blocks.

In some examples of the method, apparatuses, and non-transitory computer-readable medium described herein, the one or more polarization parameters include a first set of polarization parameters for a first set of spatial beams and a second set of polarization parameters for a second set of spatial beams.

In some examples of the method, apparatuses, and non-transitory computer-readable medium described herein, relaying the signaling may include operations, features, means, or instructions for relaying the signaling includes relaying the signaling based on the set of power parameters.

Some examples of the method, apparatuses, and non-transitory computer-readable medium described herein may further include operations, features, means, or instructions for measuring an echo interference at the repeater device based on transmission at the repeater device, where the first control message includes a first echo interference measurement for time division duplexed relaying or second echo interference measurement for bidirectional relaying.

Some examples of the method, apparatuses, and non-transitory computer-readable medium described herein may further include operations, features, means, or instructions for measuring a wireless backhaul channel using each polarization of a set of multiple polarizations at the repeater device to produce a wireless backhaul channel measurement, where the polarization measurement information includes the wireless backhaul channel measurement.

Some examples of the method, apparatuses, and non-transitory computer-readable medium described herein may further include operations, features, means, or instructions for measuring a wireless access channel using each polarization of a set of multiple polarizations at the repeater device to produce a wireless access channel measurement, where the polarization measurement information includes the wireless access channel measurement.

In some examples of the method, apparatuses, and non-transitory computer-readable medium described herein, the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

Some examples of the method, apparatuses, and non-transitory computer-readable medium described herein may further include operations, features, means, or instructions for transmitting an indication of a recommendation for the one or more polarization parameters, where the second control message indicating the one or more polarization parameters may be based on the recommendation.

In some examples of the method, apparatuses, and non-transitory computer-readable medium described herein, the control signaling indicates a first set of time resources, a second set of frequency resources, or a third set of spatial resources, for the recommendation for the one or more polarization parameters.

In some examples of the method, apparatuses, and non-transitory computer-readable medium described herein, receiving the second control message may include operations, features, means, or instructions for receiving the second control message via a downlink control information message.

In some examples of the method, apparatuses, and non-transitory computer-readable medium described herein, receiving the second control message may include operations, features, means, or instructions for receiving the second control message via a medium access control message or a radio resource control message.

In some examples of the method, apparatuses, and non-transitory computer-readable medium described herein, the first network node may be a first user equipment (UE) or a first network entity, and the second network node may be a second UE or a second network entity.

A method for wireless communications at a first network node is described. The method may include receiving, from a repeater device, a first control message indicating a capability information indicative of one or more capabilities of the repeater device and polarization measurement information at the repeater device and transmitting, to the repeater device, a second control message indicating one or more polarization parameters for the repeater device to relay signaling to a second network node based on the capability information and the polarization measurement information.

A first network node for wireless communications is described. The first network node may include a memory and at least one processor coupled to the memory. The at least one processor may be configured to receive, from a repeater device, a first control message indicating a capability information indicative of one or more capabilities of the repeater device and polarization measurement information at the repeater device and transmit, to the repeater device, a second control message indicating one or more polarization parameters for the repeater device to relay signaling to a second network node based on the capability information and the polarization measurement information.

Another apparatus for wireless communications at a first network node is described. The apparatus may include means for receiving, from a repeater device, a first control message indicating a capability information indicative of one or more capabilities of the repeater device and polarization measurement information at the repeater device and means for transmitting, to the repeater device, a second control message indicating one or more polarization parameters for the repeater device to relay signaling to a second network node based on the capability information and the polarization measurement information.

A non-transitory computer-readable medium having code for wireless communications stored thereon is described. The code may be executable by a first network node to cause the first network node to receive, from a repeater device, a first control message indicating a capability information indicative of one or more capabilities of the repeater device and polarization measurement information at the repeater device and transmit, to the repeater device, a second control message indicating one or more polarization parameters for the repeater device to relay signaling to a second network node based on the capability information and the polarization measurement information.

In some examples of the method, apparatuses, and non-transitory computer-readable medium described herein, the one or more polarization parameters indicate a first polarization for the repeater device to receive the signaling and a second polarization for the repeater device to transmit the signaling.

In some examples of the method, apparatuses, and non-transitory computer-readable medium described herein, the one or more polarization parameters indicate a first polarization for a first direction and a second polarization for a second direction.

In some examples of the method, apparatuses, and non-transitory computer-readable medium described herein, the one or more polarization parameters include a first set of polarization parameters for a first set of time and frequency resources and a second set of polarization parameters for a second set of time and frequency resources.

In some examples of the method, apparatuses, and non-transitory computer-readable medium described herein, the first set of time and frequency resources includes a first passband, a first subband, or a first set of resource blocks, and the second set of time and frequency resources includes a second passband, a second subband, or a second set of resource blocks.

In some examples of the method, apparatuses, and non-transitory computer-readable medium described herein, the one or more polarization parameters include a first set of polarization parameters for a first set of spatial beams and a second set of polarization parameters for a second set of spatial beams.

In some examples of the method, apparatuses, and non-transitory computer-readable medium described herein, the second control message indicates a set of power parameters for the repeater device to relay the signaling.

In some examples of the method, apparatuses, and non-transitory computer-readable medium described herein, the polarization measurement information indicates an echo interference at the repeater device and the polarization measurement information includes a first echo interference measurement for time division duplexed relaying or a second echo interference measurement for bidirectional relaying.

In some examples of the method, apparatuses, and non-transitory computer-readable medium described herein, the polarization measurement information indicates a wireless backhaul channel measurement for each polarization of a set of multiple polarizations at the repeater device.

In some examples of the method, apparatuses, and non-transitory computer-readable medium described herein, the polarization measurement information indicates a wireless access channel measurement for each polarization of a set of multiple polarizations at the repeater device.

In some examples of the method, apparatuses, and non-transitory computer-readable medium described herein, the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

Some examples of the method, apparatuses, and non-transitory computer-readable medium described herein may further include operations, features, means, or instructions for receiving control signaling indicating a recommendation for the one or more polarization parameters, where the second control message indicating the one or more polarization parameters may be based on the recommendation.

In some examples of the method, apparatuses, and non-transitory computer-readable medium described herein, the control signaling indicates a first set of time resources, a second set of frequency resources, or a third set of spatial resources, for the recommendation for the one or more polarization parameters.

In some examples of the method, apparatuses, and non-transitory computer-readable medium described herein, transmitting the second control message may include operations, features, means, or instructions for transmitting the second control message via a downlink control information message.

In some examples of the method, apparatuses, and non-transitory computer-readable medium described herein, transmitting the second control message may include operations, features, means, or instructions for transmitting the second control message via a medium access control message or a radio resource control message.

A method for wireless communications at a repeater device is described. The method may include measuring one or more channels at the repeater device based on a set of multiple polarizations of a set of multiple antenna panels at the repeater device to produce measurement information, selecting one or more polarization parameters for relaying signaling to a network node based on polarization measurement information, where the measurement information includes the polarization measurement information, and relaying the signaling to the network node based on the one or more polarization parameters.

A repeater device for wireless communications is described. The repeater device may include a memory and at least one processor coupled to the memory. The at least one processor may be configured to measure one or more channels at the repeater device based on a set of multiple polarizations of a set of multiple antenna panels at the repeater device to produce measurement information, select one or more polarization parameters for relaying signaling to a network node based on polarization measurement information, where the measurement information includes the polarization measurement information, and relay the signaling to the network node based on the one or more polarization parameters.

Another apparatus for wireless communications at a repeater device is described. The apparatus may include means for measuring one or more channels at the repeater device based on a set of multiple polarizations of a set of multiple antenna panels at the repeater device to produce measurement information, means for selecting one or more polarization parameters for relaying signaling to a network node based on polarization measurement information, where the measurement information includes the polarization measurement information, and means for relaying the signaling to the network node based on the one or more polarization parameters.

A non-transitory computer-readable medium having code for wireless communications stored thereon is described. The code may be executable by a repeater device to cause the repeater device to measure one or more channels at the repeater device based on a set of multiple polarizations of a set of multiple antenna panels at the repeater device to produce measurement information, select one or more polarization parameters for relaying signaling to a network node based on polarization measurement information, where the measurement information includes the polarization measurement information, and relay the signaling to the network node based on the one or more polarization parameters.

In some examples of the method, apparatuses, and non-transitory computer-readable medium described herein, selecting the one or more polarization parameters may include operations, features, means, or instructions for selecting a first polarization for receiving the signaling and a second polarization for transmitting the signaling.

In some examples of the method, apparatuses, and non-transitory computer-readable medium described herein, relaying the signaling may include operations, features, means, or instructions for receiving the signaling using the first polarization based on the one or more polarization parameters and transmitting, to the network node, the signaling using the second polarization based on the one or more polarization parameters.

In some examples of the method, apparatuses, and non-transitory computer-readable medium described herein, selecting the one or more polarization parameters may include operations, features, means, or instructions for selecting a first polarization for a first direction of the signaling and a second polarization for a second direction of the signaling.

In some examples of the method, apparatuses, and non-transitory computer-readable medium described herein, relaying the signaling may include operations, features, means, or instructions for relaying a first message in the first direction using the first polarization based on the one or more polarization parameters and relaying a second message in the second direction using the second polarization based on the one or more polarization parameters.

In some examples of the method, apparatuses, and non-transitory computer-readable medium described herein, selecting the one or more polarization parameters may include operations, features, means, or instructions for selecting the one or more polarization parameters based on the polarization measurement information satisfying a threshold.

In some examples of the method, apparatuses, and non-transitory computer-readable medium described herein, the polarization measurement information includes an echo interference measurement at the repeater device based on transmission at the repeater device and the echo interference measurement may be based on time division duplexed relaying or bidirectional relaying.

In some examples of the method, apparatuses, and non-transitory computer-readable medium described herein, the polarization measurement information includes a wireless backhaul channel measurement of a wireless backhaul channel with a network node for each polarization of the set of multiple polarizations.

In some examples of the method, apparatuses, and non-transitory computer-readable medium described herein, the polarization measurement information includes a wireless access channel measurement of a wireless access channel with a network entity or a UE for each polarization of the set of multiple polarizations.

Some examples of the method, apparatuses, and non-transitory computer-readable medium described herein may further include operations, features, means, or instructions for receiving, from a control entity, a control message indicating the threshold.

In some examples of the method, apparatuses, and non-transitory computer-readable medium described herein, selecting the one or more polarization parameters may include operations, features, means, or instructions for selecting the one or more polarization parameters for a set of resources enabled for autonomous polarization selection.

Some examples of the method, apparatuses, and non-transitory computer-readable medium described herein may further include operations, features, means, or instructions for receiving, from a control entity, a control message indicating the set of resources enabled for autonomous polarization selection.

In some examples of the method, apparatuses, and non-transitory computer-readable medium described herein, selecting the one or more polarization parameters may include operations, features, means, or instructions for selecting the one or more polarization parameters from a set of multiple sets of polarization parameters supported for autonomous polarization selection.

Some examples of the method, apparatuses, and non-transitory computer-readable medium described herein may further include operations, features, means, or instructions for receiving, from a control entity, a control message indicating the set of multiple sets of polarization parameters supported for autonomous polarization selection.

Some examples of the method, apparatuses, and non-transitory computer-readable medium described herein may further include operations, features, means, or instructions for transmitting, to the network node, a control message indicating the one or more polarization parameters.

### BRIEF DESCRIPTION OF THE DRAWINGS

FIG. 1 illustrates an example of a wireless communications system that supports techniques for handling self-oscillation at repeaters in accordance with one or more aspects of the present disclosure.

FIG. 2 illustrates an example of a wireless communications system that supports techniques for handling self-oscillation at repeaters in accordance with one or more aspects of the present disclosure.

FIG. 3 illustrates examples of TDD repeater polarization schemes that support techniques for handling self-oscillation at repeaters in accordance with one or more aspects of the present disclosure.

FIG. 4 illustrates examples of bidirectional repeater polarization schemes that support techniques for handling self-oscillation at repeaters in accordance with one or more aspects of the present disclosure.

FIG. 5 illustrates an example of a process flow that supports techniques for handling self-oscillation at repeaters in accordance with one or more aspects of the present disclosure.

FIGS. 6 and 7 show block diagrams of devices that support techniques for handling self-oscillation at repeaters in accordance with one or more aspects of the present disclosure.

FIG. 8 shows a block diagram of a communications manager that supports techniques for handling self-oscillation at repeaters in accordance with one or more aspects of the present disclosure.

FIG. 9 shows a diagram of a system including a device that supports techniques for handling self-oscillation at repeaters in accordance with one or more aspects of the present disclosure.

FIGS. 10 and 11 show block diagrams of devices that support techniques for handling self-oscillation at repeaters in accordance with one or more aspects of the present disclosure.

FIG. 12 shows a block diagram of a communications manager that supports techniques for handling self-oscillation at repeaters in accordance with one or more aspects of the present disclosure.

FIG. 13 shows a diagram of a system including a device that supports techniques for handling self-oscillation at repeaters in accordance with one or more aspects of the present disclosure.

FIGS. 14 through 16 show flowcharts illustrating methods that support techniques for handling self-oscillation at repeaters in accordance with one or more aspects of the present disclosure.

### DETAILED DESCRIPTION

A wireless communications systems may implement a repeater device to relay signaling between two network nodes, such as between a user equipment (UE) and a network entity or between two UEs. The repeater device may be configured as a time division duplexing (TDD) repeater or a bidirectional repeater. A TDD repeater may forward signals in one direction at a time, while a bidirectional repeater may forward signals simultaneously in two directions, such as relaying uplink signaling and downlink signaling simultaneously. A repeater device may be configured with multiple polarizations for relaying signaling. For example, a TDD repeater may include two amplification chains, where a first amplification chain forward incoming signals using horizontally polarized antenna panels, and a second amplification chain is used to forward incoming signals using vertically polarized antenna panels. In some cases, the repeater device may experience signal interference or clutter echo, which may lead to oscillation and instability. For example, a TDD repeater device may receive signaling at receive antennas and transmit the signaling using transmit antennas, but the transmitted signaling may be reflected back to the repeater device and picked up by the receive antennas. If the repeater device experiences strong interference or clutter echo, the repeater may back off amplification gain, which may reduce signal strength of the relayed signaling.

Wireless communications systems described herein support techniques for a repeater device to use orthogonal polarizations of antenna panels when forwarding signaling to mitigate interference. In some examples, a TDD repeater device may be configured to apply orthogonal polarizations for transmission and reception to reduce interference and clutter echo. For example, the TDD repeater may be configured to use vertically polarization antenna panels for reception and a horizontally polarization for transmission. Additionally, or alternatively, a bidirectional repeater may be configured to apply orthogonal polarizations for relaying in different directions. For example, the TDD repeater may use antenna panels with a vertical polarization to relay uplink signaling and use antenna panels with a horizontal polarization to relay downlink signaling. In some examples, the repeater device may indicate a capability of supporting orthogonal polarization configurations to a network entity and indicate a measurement of channels or interference at the repeater device. For example, the repeater device may indicate a measurement of clutter echo or self-interference. The network entity may configure the repeater device with a set of one or more polarization parameters for relaying signaling between two network nodes, and the repeater device may relay signaling between the network nodes based on the indicated set of one or more polarization parameters.

In some examples, the repeater device may perform the measurements and select the set of one or more polarization parameters autonomously. The repeater may measure a clutter echo at antenna panels of the repeater device, detect that the clutter echo is affecting reception at the repeater device, and select polarization parameters to apply orthogonal polarizations for transmission and reception (e.g., as a TDD repeater) or different directions (e.g., as a bidirectional repeater). In some examples, the repeater device may select the polarization parameters based on a configuration received from a control entity (e.g., a UE or network entity). For example, the repeater device may select the polarization parameters based on indicated thresholds for the measurements, resources supported for autonomous parameter selection, or from a set of supported polarization configurations.

Aspects of the disclosure are initially described in the context of wireless communications systems. Aspects of the disclosure are further illustrated by and described with reference to apparatus diagrams, system diagrams, and flowcharts that relate to techniques for handling self-oscillation at repeaters.

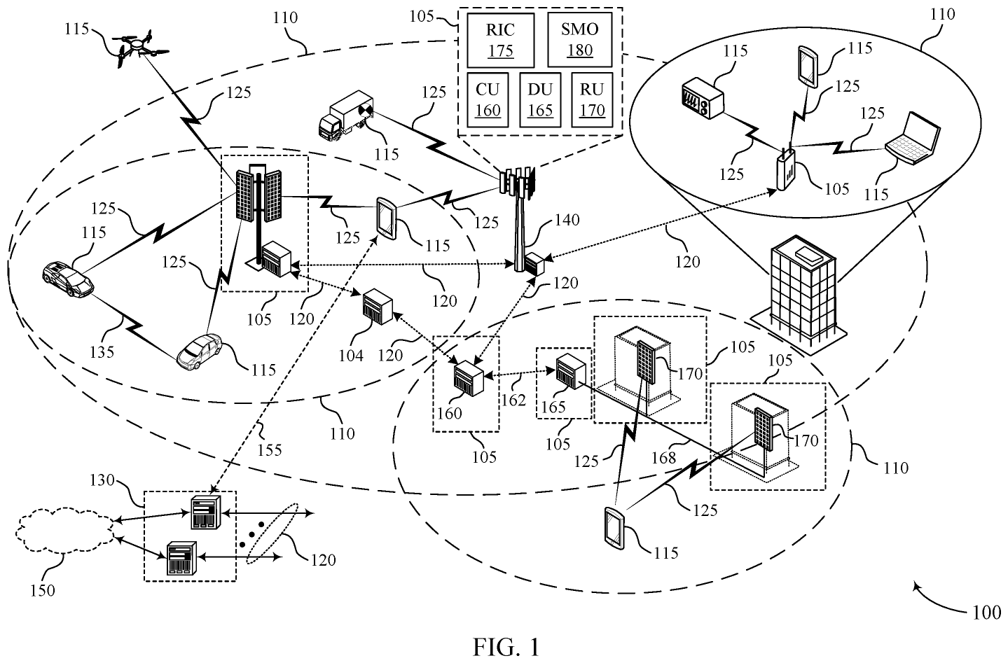

FIG. 1 illustrates an example of a wireless communications system 100 that supports techniques for handling self-oscillation at repeaters in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for handling self-oscillation at repeaters as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T, =1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other aspects, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A repeater device may be configured to use orthogonal polarizations of antenna panels when forwarding signaling to mitigate interference. In some aspects, a TDD repeater device may be configured to apply orthogonal polarizations for transmission and reception to reduce interference and clutter echo. For example, the TDD repeater may be configured to use vertically polarization antenna panels for reception and a horizontally polarization for transmission. Additionally, or alternatively, a bidirectional repeater may be configured to apply orthogonal polarizations for relaying in different directions. For example, the TDD repeater may use antenna panels with a vertical polarization to relay uplink signaling and use antenna panels with a horizontal polarization to relay downlink signaling. In some aspects, the repeater device may indicate a capability of supporting orthogonal polarization configurations to a network entity and indicate a measurement of channels or interference at the repeater device. For example, the repeater device may indicate a measurement of clutter echo or self-interference. The network entity may configure the repeater device with a set of one or more polarization parameters for relaying signaling between two network nodes, and the repeater device may relay signaling between the network nodes based on the indicated set of one or more polarization parameters.

In some aspects, the repeater device may perform the measurements and select the set of one or more polarization parameters (e.g., autonomously). The repeater may measure a clutter echo at antenna panels of the repeater device, detect that the clutter echo is affecting reception at the repeater device, and select polarization parameters to apply orthogonal polarizations for transmission and reception (e.g., as a TDD repeater) or different directions (e.g., as a bidirectional repeater). In some aspects, the repeater device may select the polarization parameters based on a configuration received from a control entity (e.g., a UE 115 or a network entity 105). For example, the repeater device may select the polarization parameters based on indicated thresholds for the measurements, resources supported for autonomous parameter selection, or from a set of supported polarization configurations.

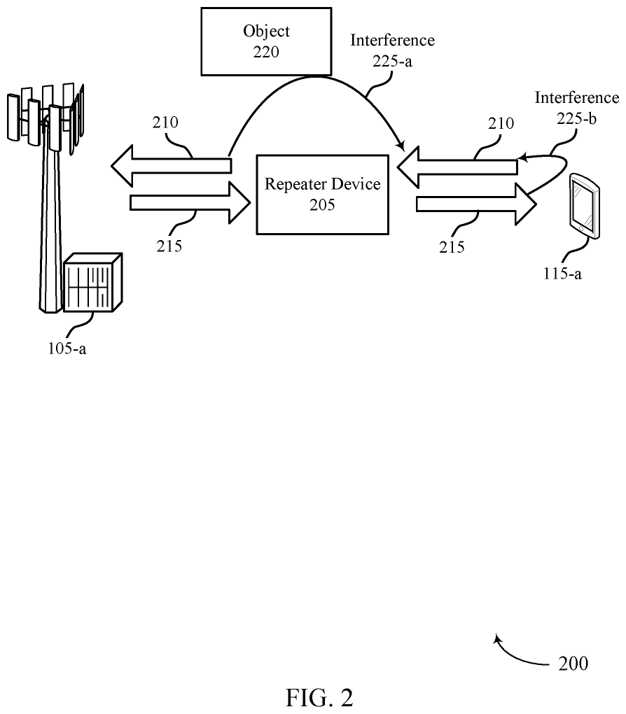

FIG. 2 illustrates an example of a wireless communications system 200 that supports techniques for handling self-oscillation at repeaters in accordance with one or more aspects of the present disclosure. The wireless communications system may include a UE 115-a and a network entity 105-a, which may be respective examples of a UE 115 and a network entity 105 described herein.

The wireless communications system may include a repeater device 205, which may relay signaling between two network nodes, such as between the UE 115-a and the network entity 105-a or between two UEs 115. In some aspects, an intelligent reflective surface (IRS), a repeater, or a relay may be an example of the repeater device 205. For example, the UE 115-a may transmit uplink signaling 210 to the repeater device 205, and the repeater device may forward the uplink signaling 210 to the network entity 105-a. Similarly, the network entity 105-a may transmit downlink signaling 215 to the repeater device 205, and the repeater device 205 may forward or relay the downlink signaling 215 to the UE 115-a.

The repeater device 205 may be, or may be configured as, a TDD repeater or a bi-directional repeater. A TDD repeater may forward signals only in one direction at a time, such as either forwarding uplink signaling or downlink signaling at a time. A bidirectional repeater may forward signals simultaneously in multiple directions, such as by relaying both uplink signaling and downlink signaling at the same time.

In some aspects, the repeater device 205 may experience some self-interference or clutter echo. For example, the repeater device 205 may relay the uplink signaling 210, but the uplink signaling 210 may be reflected off of an object 220. The reflection of the uplink signaling 210 may be picked up (e.g., received) at receiver antennas of the repeater device, resulting in a loop for the uplink signaling 210 and an interference 225-a (e.g., a self-interference or clutter echo). If the repeater device 205 applies an amplification gain to received signaling (e.g., and a loop gain for the interference 225-a is above 1), this may result in an oscillation at the repeater device 205 and instability. For example, the repeater device 205 may continuously receive reflections of the uplink signaling 210, apply an amplification gain to the reflected signal, and relay the reflected signal, which may be again be reflected and received at the repeater device 205.

In some aspects, the repeater device 205 may be configured with a transmit power or amplification gain to prevent oscillation or instability. However, if the interference or clutter echo is strong, the repeater device 205 may apply a backoff to the amplification gain, which may reduce signal strength or signal quality.

A bidirectional repeater may also experience cross-link interference. For example, the repeater device 205 may relay the uplink signaling 210 while relaying the downlink signaling 215. The downlink signaling 215 may also be reflected back to the repeater device 205 and received by antenna panels of the repeater device 205. Therefore, the repeater device 205 may relay the reflection of the downlink signaling 215 back to the network entity 105-a, which may result in an interference 225-b (e.g., a cross-link interference).

The repeater device 205 may be equipped with antenna panels that are polarized horizontally or vertically. In some aspects, the repeater device 205 may have 2N receive antennas with N receive antennas per polarization, and 2M transmit antennas with M transmit antennas per polarization. In some aspects, the repeater device 205 may have a same quantity of transmit antennas as receive antennas (e.g., M=N). In some cases, a TDD repeater may have two amplification chains to forward the incoming signals across like-polarized antennas. For example, the TDD repeater may receive signaling using a horizontally polarized receive antenna, amplify gain of the signaling via the amplification chain, and transmit (e.g., forward) the amplified signaling using a horizontally polarized transmit antenna. Signaling received on a vertically polarized receive antenna may also be amplified via another amplification chain and transmitted using a vertically polarized transmit antenna.

In some aspects, the repeater device 205 may use same analog beams for both horizontally polarized and vertically polarized antenna (e.g., for both transmission and reception). For example, signaling transmitted via a transmit beam formed at horizontally polarized transmit antennas may use a same analog beam (e.g., same analog beam weights) as a transmit beam formed at vertically polarized antennas.

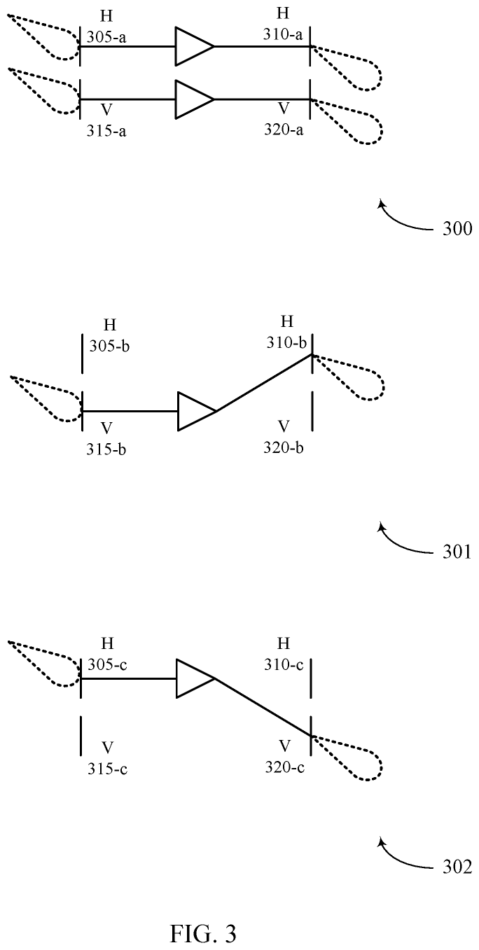

The wireless communications system 200 may support techniques for a repeater, such as the repeater device 205, to apply orthogonal polarizations when relaying signaling to reduce an impact of interference. For example, if the repeater device 205 is operating as a TDD repeater, the repeater device 205 may receive signaling via a horizontally polarized antenna, perform an amplification gain to the signaling, and transmit the signaling via a vertically polarized antenna. This may mitigate clutter echo or self-interference, as the signaling from the vertically polarized antenna may not be received at the horizontally polarized receive antenna of the repeater device 205. An example of a TDD repeater applying polarization parameters to use orthogonal polarizations is described in more detail with reference to FIG. 3.

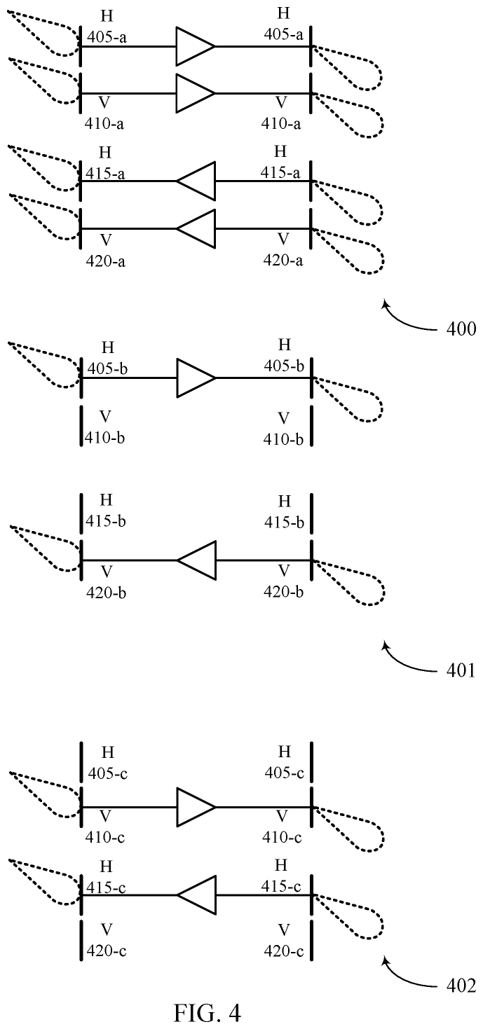

In another example, if the repeater device 205 is operating as a bidirectional repeater, the repeater device 205 may be configured to relay downlink signaling and uplink signaling using different polarizations. For example, the repeater device 205 may be configured with four amplification chains, using two amplification chains (e.g., one with a vertical polarization and one amplification chain with a horizontal polarization) to relay downlink signaling and uplink signaling each. The repeater device 205 may be configured to receive and forward downlink signaling using a horizontal polarization (e.g., and not a vertical polarization), and the repeater device 205 may be configured to receive and forward uplink signaling using a vertical polarization (e.g., and not a horizontal polarization). An example of a bidirectional repeater applying polarization parameters to use orthogonal polarizations is described in more detail with reference to FIG. 4.

In some aspects, the repeater device 205 may indicate a capability of supporting different polarization or forwarding configurations to a control entity, such as the network entity 105-a or the UE 115-a. For example, the repeater device 205 may transmit a control message indicating a capability of the repeater device 205 to support alternative polarization or forwarding configurations. The repeater device 205 may indicate a capability to support bidirectional repeating or TDD repeating, or both. In some cases, the repeater device 205 may indicate support for orthogonal polarization schemes as a TDD repeater or as a bidirectional repeater.

The control entity, such as the network entity 105-a, may transmit control signaling to the repeater device 205 to indicate a polarization or forwarding configuration for upcoming resources. For example, the network entity 105-a may transmit control signaling to the repeater device 205 indicating one or more polarization parameters. The configuration may be indicated in terms of a pair of polarizations to be used for TDD repeaters or bidirectional repeaters. For example, the control signaling may indicate for a TDD repeater to use a pair of polarizations that includes a vertical polarization for reception and a horizontal polarization for transmission. Additionally, or alternatively, the control signaling may indicate for a bidirectional repeater to use a pair of polarizations that includes a vertical polarization for a first direction (e.g., uplink) and use a horizontal polarization for a second direction (e.g., downlink). These configurations are exemplary, and additional or alternative configurations may be supported or indicated.

In some aspects, the repeater device 205 may be configured with polarization parameters dynamically, semi-statically, or semi-persistently. For example, the network entity 105-a may transmit a dynamic or aperiodic control message (e.g., a downlink control information message) to the repeater device 205 to indicate one or more polarization parameters for the repeater device 205 to apply when relaying or forwarding signaling. Additionally, or alternatively, the network entity 105-a may transmit a semi-persistent message (e.g., a MAC message) indicating the one or more polarization parameters. Additionally, or alternatively, the repeater device 205 may be statically or semi-statically configured with the polarization parameters, such as via an RRC message from the network entity 105-a.

In some aspects, different modes or polarization parameters may be selected or associated with different sets of resources. For example, the repeater device 205 may be configured to apply a first set of one or more polarization parameters for a first set of time and frequency resources and apply a second set of one or more polarization parameters for a second set of time frequency resources. In some aspects, the repeater device 205 may apply, or may be configured to apply, different polarization parameters for different passbands, subbands, or resource block sets. For example, the repeater device 205 may receive via horizontally polarized antennas and transmit via vertically polarized antennas in a first subband, and the repeater device 205 may receive via vertically polarized antennas and transmit via horizontally polarized antennas in a second subband. Similarly, different polarization parameters may be selected and applied for different spatial resources, such as for different beams used for a backhaul link (e.g., with the network entity 105-a) or an access link (e.g., with the network entity 105-a or the UE 115-a).

In some aspects, the control signaling indicating the polarization parameters may indicate resources (e.g., time and frequency or spatial resources) for the repeater device 205 to apply the polarization parameters. For example, the control signaling may indicate a first set of polarization parameters for a first set of resource blocks and indicate a second set of polarization parameters for a second set of resource blocks.

In some aspects, different power configurations or other control information may be indicated in association with different polarization or forwarding configurations. For example, the network entity 105-a may transmit an indication of transmit power parameters to the repeater device 205, and the repeater device 205 may apply the transmit power parameters when relaying signaling in accordance with the one or more polarization parameters. In some aspects, the power parameters may be indicated by the same control signaling indicating the polarization parameters or via separate control signaling. In some aspects, a power configuration, or the power parameters, may be indicated per set of polarization parameters or per spatial resource. For example, the network entity 105-a may indicate a first set of power parameters to use when relaying signaling in accordance with the one or more polarization parameters for one or more indicated spatial beams.

In some cases, the control entity (e.g., the network entity 105-a) may select the one or more polarization parameters based on one or more measurements indicated by the repeater device 205. The repeater device 205 may indicate the one or more measurements via the capability signaling or via a separate control message.

In some aspects, the network entity 105-a may select the polarization parameters based on a measurement taken by a remote UE 115, such as the UE 115-a. For example, the UE 115-a may perform measurements on signaling transmitted via one or more vertically polarized antennas and on signaling transmitted via one or more horizontally polarized antennas. The UE 115-a may transmit a measurement report to the network entity 105-a (e.g., via the repeater device 205) indicating measurements corresponding to the vertically polarized antennas and the horizontally polarized antennas. If, for example, the UE 115-a can receive signaling from vertically polarized antennas with a higher signal strength or signal quality, the network entity 105-a may configure the repeater device 205 to receive signaling from the network entity 105-a using one or more horizontally polarized antennas and transmit the signaling to the UE 115-a using one or more vertically polarized antennas. This may result in higher signal strength and signal quality when relaying signaling to the UE 115-a.

In some aspects, the network entity 105-a may select the polarization parameters based on measurements taken by the repeater device 205. For example, the repeater device 205 may measure interference, such as the interference 225-a for clutter echo or the interference 225-b for cross-link interference. The repeater device 205 may transmit an indication of a measurement of the interference to the network entity 105-a. The network entity 105-a may select the one or more polarization parameters for the repeater device 205 based on the measurements. For example, the network entity 105-a may configure the repeater device 205 to apply orthogonal polarizations if the repeater device 205 experiences cross-link interference or self-interference, such as if the network entity 105-a determines the measurements of the interference exceed a threshold.

In some aspects, the repeater device 205 may measure the backhaul channel link or one or more access channel links to produce per-polarization channel measurements of the backhaul channel link or one or more access channel links. The repeater device 205 may indicate the per-polarization channel measurements to the network entity 105-a, and the network entity 105-a may determine the one or more polarization parameters based on the per-polarization channel measurements. In some aspects, the network entity 105-a may select the one or more polarization parameters based on measurements based by the network entity 105-a. For example, the network entity 105-a may measure uplink signaling from the repeater device 205 or signaling from the UE 115-a which is relayed (e.g., forwarded) by the repeater device 205. The network entity 105-a may determine the one or more polarization parameters based on the measurements of the signaling from the repeater device 205 or the measurements of the signaling from the UE 115-a (e.g., relayed by the repeater device 205).

In some aspects, the repeater device 205 may indicate a supported power configurations. For example, the repeater device 205 may indicate a supported amplification gain (e.g., a maximum amplification gain) supported for each configuration of orthogonal polarization relaying. For example, the repeater device 205 may indicate a first supported amplification gain for orthogonally polarized relaying when operating as a TDD repeater, or the repeater device 205 may indicate a second supported amplification gain for orthogonally polarized relaying when operating as a bidirectional repeater. In some cases, the repeater device 205 may indicate supported amplification gains for different polarization parameters or sets of polarization parameters. For example, the repeater device 205 may indicate a first supported amplification gain for receiving using a first polarization and transmitting using a second polarization and a second supported amplification gain for receiving using the second polarization and transmitting using the first polarization.

In some aspects, the repeater device 205 may select the one or more polarization parameters. For example, the repeater device 205 may perform channel measurements or polarization measurements and select the one or more polarization parameters based on the measurements. In an example, the repeater device 205 may measure a channel access link with the UE 115-a using different polarizations, and the repeater device 205 may select polarization parameters for orthogonal polarization relaying to the UE 115-a based on measurements of the channel access link. For example, the repeater device 205 may select polarization parameter to receive the downlink signaling 215 using a horizontal polarization and to transmit (e.g., forward) the downlink signaling 215 using a vertical polarization. In some cases, the repeater device 205 may select the polarization parameters in accordance with an autonomous polarization selection procedure. For the autonomous polarization selection procedure, the repeater device 205 may perform measurements and select the polarization parameters. For example, the repeater device 205 may select the polarization parameters instead of another network node or control entity.

In some aspects, the repeater device 205 may select the one or more polarization parameters in accordance with thresholds, configurations, or rules indicated by another network node. For example, a control entity, such as the network entity 105-a or the UE 115-a, may transmit control signaling to configure the repeater device 205 with one or more rules or configurations for selecting the polarization parameters. In some aspects, the rules or configurations may include one or more thresholds for selecting the polarization parameters, one or more resources in which autonomous polarization selection is enabled, or supported configurations for autonomous polarization selection.

For example, the repeater device 205 may measure a wireless channel to obtain a wireless channel measurement and select polarization parameters based on the wireless channel measurement satisfying a threshold. The repeater device 205 may select a set of polarization parameters from multiple supported sets of polarization parameters, which may be indicated by the control entity. In some aspects, the repeater device 205 may apply the selected set of polarization parameters to relay signaling on a set of resources supported, or authorized, for relaying in accordance with the selected set of polarization parameters.

In some aspects, the repeater device 205 may indicate the selected polarization parameters to network nodes for which the repeater device 205 is relaying signaling. For example, the repeater device 205 may relay signaling between the UE 115-a and the network entity 105-a. The repeater device 205 may select polarization parameters in accordance with an autonomous polarization selection, and the repeater device may transmit an indication of the selected polarization parameters to the UE 115-a or the network entity 105-a. In some other examples, the repeater device 205 may not indicate the selected polarization parameters to at least one of the remote entities (e.g., the network nodes), and the at least one remote entities may continue transmitting or receiving using both polarizations for communications without being indicated the polarization configuration or forwarding configuration selected by the repeater device 205.

While some techniques described herein are generally discussed with respect to the repeater device 205 relaying signaling between a UE 115 (e.g., the UE 115-a) and a network entity 105 (e.g., the network entity 105-a), techniques described herein may be implemented for relaying signaling between other devices or other types of devices. For example, the repeater device 205 may similarly be configured with polarization parameters, or select polarization parameters, to relay signaling between any two network nodes, such as sidelink signaling between two UEs 115 or signaling between two network entities 105, among other devices.

FIG. 3 illustrates examples of TDD repeater polarization schemes 300, 301, and 302 that support techniques for handling self-oscillation at repeaters in accordance with one or more aspects of the present disclosure. The TDD repeater polarization schemes 300, 301, and 302 may be implemented by a TDD repeater device or a repeater device which supports relaying or forwarding signaling according to TDD repeating techniques.

The TDD repeater polarization scheme 300 may be an example of a baseline TDD repeater polarization configuration. For example, a TDD repeater device may have two amplification chains, where a first amplification chain includes a first receive antenna 305-a and a first transmit antenna 310-a with a first polarization (e.g., a horizontal polarization). A second amplification chain may include a second receive antenna 315-a and a second transmit antenna 320-a with a second, complementary polarization (e.g., a vertical polarization). The TDD repeater device may, for example, receive signaling at the first receive antenna 305-a with a horizontal polarization, apply an amplification gain to the signaling, and forward (e.g., transmit) the amplified signaling via the first transmit antenna 310-a with the horizontal polarization. The TDD repeater device may also receive signaling at the second receive antenna 315-a with a vertical polarization, apply an amplification gain to the signaling, and forward (e.g., transmit) the amplified signaling via the second transmit antenna 320-a with the vertical polarization.

The TDD repeater polarization scheme 301 may be implemented by a TDD repeater device which has applied one or more polarization parameters. For example, the TDD repeater device may apply indicated, or selected, polarization parameters to apply orthogonal polarizations for transmission and reception. For example, the TDD repeater implementing the TDD repeater polarization scheme 301 may receive signaling via a second receive antenna 315-b with a vertical polarization and apply an amplification gain to the received signaling. The TDD repeater implementing the TDD repeater polarization scheme 301 may transmit, or forward, the amplified signaling via a first transmit antenna 310-b with a horizontal polarization. Therefore, the signaling may be received using a vertical polarization and transmitted using a horizontal polarization. By using orthogonal polarizations to receive and transmit signaling, the TDD repeater may reduce cross-polarization interference, and the TDD repeater device may apply a larger amplification gain. In some aspects, the TDD repeater may not provide power to the first receive antenna 305-b or the second transmit antenna 320-b, or the TDD repeater may otherwise not use these antenna elements to relay the signaling (e.g., at least to one or more network nodes) for the TDD repeater polarization scheme 301.

The TDD repeater polarization scheme 302 may be implemented by a TDD repeater device which has applied one or more polarization parameters. For example, the TDD repeater device may apply indicated, or selected, polarization parameters to apply orthogonal polarizations for transmission and reception. In the example of the TDD repeater polarization scheme 302, a TDD repeater device may receive signaling via a first receive antenna 305-c with a horizontal polarization and apply an amplification gain to the received signaling. The TDD repeater implementing the TDD repeater polarization scheme 302 may transmit, or forward, the amplified signaling via a second transmit antenna 320-c with a vertical polarization. Therefore, the signaling may be received using a horizontal polarization and transmitted using a vertical polarization. In some aspects, the TDD repeater may not provide power to the second receive antenna 315-c or the first transmit antenna 310-c, or the TDD repeater may otherwise not use these antenna elements to relay the signaling (e.g., at least to one or more network nodes) for the TDD repeater polarization scheme 302.

A TDD repeater may implement any one or more of the TDD repeater polarization schemes described herein. In some aspects, the TDD repeater may be configured with, or may select, one or more of the TDD repeater polarization schemes based on measurements of an access link channel or a backhaul link channel. For example, a network node may receive forwarded signaling with a higher signal strength when the TDD repeater transmits the signaling with a vertical polarization. In this example, the TDD repeater may apply, or may be configured to apply, the TDD repeater polarization scheme 302 to forward signaling to the network node.

In some aspects, the TDD repeater may apply, or may be configured to apply, one or more of the orthogonal polarization schemes based on interference measurements. For example, the TDD repeater may transmit an indication of clutter echo at the TDD repeater to a control entity, such as a network entity 105. The clutter echo may occur based on a reflection of forwarded signaling from the TDD repeater being received at one of the receive antennas of the TDD repeater. The control entity may configure the TDD repeater to apply one or more polarization parameters to use orthogonal polarizations for receiving signaling and transmitting signaling. Additionally, or alternatively, the TDD repeater may detect the interference and select one or more polarization parameters (e.g., for an orthogonal polarization scheme) to use for relaying signaling.

FIG. 4 illustrates examples of bidirectional repeater polarization schemes 400, 401, and 402 that support techniques for handling self-oscillation at repeaters in accordance with one or more aspects of the present disclosure. The bidirectional repeater polarization schemes 400, 401, and 402 may be implemented by a bidirectional repeater device or a repeater device which supports relaying or forwarding signaling according to bidirectional repeating techniques.

The bidirectional repeater polarization scheme 400 may be implemented by a baseline bidirectional repeater polarization configuration. For example, a bidirectional repeater device may have four amplification chains. A first amplification chain 405-a may include a first receive antenna and a first transmit antenna, where the antenna elements of the first amplification chain 405-a have a first polarization (e.g., a horizontal polarization). A second amplification chain 410-a may include a second receive antenna and a second transmit antenna, where the antenna elements of the second amplification chain 410-a have a second polarization (e.g., a vertical polarization), which may be complementary to the first polarization. A third amplification chain 415-a include antenna elements with the first polarization (e.g., the horizontal polarization), and a fourth amplification chain 420-a may have antenna elements with the second polarization (e.g., the vertical polarization).

The bidirectional repeater device may support relaying or forwarding of signaling in two different directions simultaneously. For example, the bidirectional repeater may receive and transmit (e.g., relay or forward) signaling in a first direction using the first amplification chain 405-a and the second amplification chain 410-a, and the bidirectional repeater may receive and transmit (e.g., relay or forward) signaling in a second direction using the third amplification chain 415-a and the fourth amplification chain 420-a. In an example, the bidirectional repeater may receive uplink signaling via receive antenna elements of the first amplification chain 405-a and the second amplification chain 410-a, apply an amplification gain to the received signaling, and transmit the amplified uplink signaling via transmit antenna elements of the first amplification chain 405-a and the second amplification chain 410-a. The uplink signaling may be relayed via both horizontally polarized antenna elements and vertically polarized antenna elements.

The bidirectional repeater polarization scheme 401 may be implemented by a bidirectional repeater device which has applied one or more polarization parameters. For example, the bidirectional repeater device may apply indicated, or selected, polarization parameters to apply orthogonal polarizations for different directions of signaling. For example, the bidirectional repeater implementing the bidirectional repeater polarization scheme 401 may receive and transmit (e.g., forward) signaling in a first direction using a first amplification chain 405-b with a first polarization, and the bidirectional repeater may receive and transmit signaling in a second direction using a fourth amplification chain 420-b with a second polarization. For example, the bidirectional repeater implementing the bidirectional repeater polarization scheme 401 may receive, amplify, and transmit (e.g., forward) downlink signaling via antenna elements of the first amplification chain 405-b with a horizontal polarization, and the bidirectional repeater may receive, amplify, and transmit uplink signaling via antenna elements of the fourth amplification chain 420-b with a vertical polarization.

Therefore, signaling in a first direction may be relayed (e.g., received and transmitted) using a horizontal polarization, and signaling in a second direction may be relayed using a vertical polarization. By using orthogonal polarizations to relay signaling in different directions, the bidirectional repeater may reduce cross-polarization interference and cross-link interference, and the bidirectional repeater device may apply a larger amplification gain. In some aspects, the bidirectional repeater may not provide power to a second amplification chain 410-b or a third amplification chain 415-b, or the bidirectional repeater may otherwise not use antenna elements of these amplification chains to relay signaling (e.g., at least to one or more network nodes).

The bidirectional repeater polarization scheme 402 may be implemented by a bidirectional repeater device which has applied one or more polarization parameters. For example, the bidirectional repeater device may apply indicated, or selected, polarization parameters to apply orthogonal polarizations to relay signaling in different directions For example, the bidirectional repeater implementing the bidirectional repeater polarization scheme 402 may receive and transmit (e.g., forward) signaling in a first direction using a second amplification chain 410-c with a first polarization, and the bidirectional repeater may receive and transmit signaling in a second direction using a third amplification chain 415-c with a second polarization. For example, the bidirectional repeater implementing the bidirectional repeater polarization scheme 402 may receive, amplify, and transmit (e.g., forward) downlink signaling via antenna elements of the second amplification chain 410-c with a vertical polarization, and the bidirectional repeater may receive, amplify, and transmit uplink signaling via antenna elements of the third amplification chain 415-c with a horizontal polarization. In some aspects, the bidirectional repeater may not provide power to a first amplification chain 405-c or a fourth amplification chain 420-c, or the bidirectional repeater may otherwise not use antenna elements of these amplification chains to relay signaling (e.g., at least to one or more network nodes).

A bidirectional repeater may implement any one or more of the bidirectional repeater polarization schemes described herein. In some aspects, the bidirectional repeater may be configured with, or may select, one or more of the bidirectional repeater polarization schemes based on measurements of an access link channel or a backhaul link channel.

In some aspects, the bidirectional repeater may apply, or may be configured to apply, one or more of the orthogonal polarization schemes based on interference measurements. For example, the bidirectional repeater may transmit an indication of clutter echo at the bidirectional repeater to a control entity, such as a network entity 105. The clutter echo may occur based on a reflection of signaling in a first direction being received at one of the receive antennas of the bidirectional repeater used for a second direction. The control entity may configure the bidirectional repeater to apply one or more polarization parameters to use orthogonal polarizations for signaling in different directions. Additionally, or alternatively, the bidirectional repeater may detect the interference and select one or more polarization parameters (e.g., for an orthogonal polarization scheme) to use for relaying signaling in different directions.

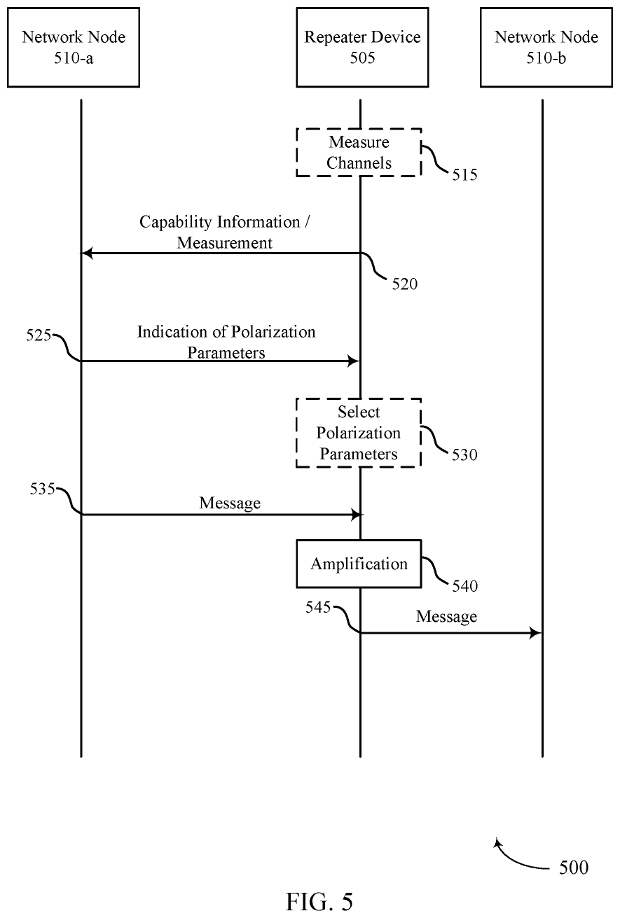

FIG. 5 illustrates an example of a process flow 500 that supports techniques for handling self-oscillation at repeaters in accordance with one or more aspects of the present disclosure. The process flow 500 may be implemented by one or more network nodes. For example, the process flow 500 may be implemented by a repeater device 505, which may be an example of a repeater device or a network node described herein. In some aspects, the process flow 500 may be implemented by a first network node, which may be an example of a control unit, a UE 115, or a network entity 105 described herein. In some aspects, the process flow 500 may be implemented by a second network node, which may be an example of a UE 115 or a network entity 105 described herein.

The repeater device 505 may relay signaling between network nodes. For example, the repeater device 505 may relay signaling between the network node 510-a and the network node 510-b. In some other examples, the repeater device 505 may relay signaling between other network nodes. For example, the repeater device 505 may relay signaling from another network node to the network node 510-b.

At 515, the repeater device 505 may perform measurements of one or more channels at the repeater device 505 to produce a channel measurement. For example, the repeater device 505 may measure an echo interference at the repeater device 505 based on transmission at the repeater device 505. For example, the repeater device 505 may be a TDD repeater which transmit signaling using a transmit antenna, and the transmitted signaling may be reflected and received at a receive antenna of the repeater device 505. In this example, the reflection of the signaling may interfere with reception at the receive antenna. The repeater device 505 may measure interference caused by the reflection of the transmitted signaling.

In another example, the repeater device 505 may experience and measure cross-link interference. For example, the repeater device 505 may be a bidirectional repeater which relays signaling in two directions simultaneously. Signaling in a first direction may be reflected back to the repeater, picked up by receive antennas, and relayed in the second direction (e.g., back to the original transmitter). In some aspects, the repeater device 505 may measure the cross-link interference caused by the reflection of the signaling.

In some cases, the repeater device 505 may measure channel characteristics based on different polarizations of the repeater device. For example, the repeater device 505 may measure a wireless backhaul channel using each polarization of a set of multiple polarizations at the repeater to produce a wireless backhaul channel measurement. In some aspects, the wireless backhaul channel may be established with the network node 510-a or a network entity 105-a. Additionally, or alternatively, the repeater device 505 may measure a wireless access channel using each polarization of the set of multiple polarizations at the repeater device 505 to produce a wireless access channel measurement. The wireless access channel may be established with the network node 510-a or a network entity 105, or the wireless access channel may be established with the network node 510-b or a UE 115.

In some aspects, the repeater device 505 may transmit an indication of capability information and a measurement of the one or more channels at 520. For example, the repeater device 505 may transmit, to the network node 510-a, a first control message indicating capability information indicative of one or more capabilities of the repeater device. In some aspects, the first control message may include polarization measurement information at the repeater device. For example, the first control message may indicate an echo interference measurement, a cross-link interference measurement, a wireless backhaul channel measurement, or a wireless access channel measurement.

In some aspects, the network node 510-a may select one or more polarization parameters for the repeater device 505 to apply based on the one or more capabilities of the repeater device or the measurement information (e.g., the polarization measurement information). For example, the network node 510-a may select polarization parameters for the repeater device 505 to reduce self-interference or echo interference at the repeater device 505 based on an orthogonal polarization scheme. In some aspects, the network node 510-a may select the polarization parameters for the repeater device 505 based on the measurement information satisfying a threshold. For example, the measurement information may satisfy an RSRP threshold, an SINR threshold, or an RSSI threshold. In an example, the measurement information may not exceed the SINR threshold, which may indicate that the repeater device 505 is experience interference.

In some aspects, the network node 510-a may receive measurement information from another network node (e.g., the network node 510-b) which receives relayed signaling from the repeater device 505. For example, the network node 510-b may report measurement information for received signaling from the repeater device 505. Based on the reported measurement information from the network node 510-b or the repeater device 505, the network node 510-a may, for example, identify a polarization which, when used to forward signaling, results in a higher signal quality or higher signal strength at the network node 510-b. The network node 510-a may, in some cases, perform measurements on signaling received from the repeater device 505 and select the polarization parameters based on the measurements performed at the network node 510-a.

At 525, the network node 510-a may transmit an indication of the selected polarization parameters to the repeater device 505. For example, the repeater device 505 may receive a second control message indicating one or more polarization parameters based on the capability information and the polarization measurement information.

The polarization parameters may configure the repeater device 505 to apply orthogonal polarizations when relaying signaling. For example, the repeater device 505 may operate as a TDD repeater, and the one or more polarization parameters may indicate a first polarization for receiving signaling and a second polarization for transmitting the signaling. In another example, the repeater device 505 may operate as a bidirectional repeater, and the one or more polarization parameters may indicate a first polarization for a first direction and a second polarization for a second direction.

In some aspects, the second control message may indicate resources for applying the polarization parameters or different sets of polarization parameters for different resources. For example, the one or more polarization parameters may include a first set of polarization parameters for a first set of time and frequency resources and a second set of polarization parameters for a second set of time and frequency resources. The first set of time and frequency resources may include a first passband, a first subband, or a first set of resource blocks, and the second set of time and frequency resources may include a second passband, a second subband, or a second set of resource blocks. In some aspects, the one or more polarization parameters may include a first set of polarization parameters for a first set of spatial resources (e.g., a first set of spatial beams) and a second set of polarization parameters for a second set spatial resources (e.g., a second set of spatial beams).

In some aspects, the second control message may indicate power parameters for relaying signaling. For example, the second control message may indicate an amplification gain, a maximum transmit power or a power backoff for the repeater device 505 to apply when relaying signaling in accordance with the one or more polarization parameters.

The polarization parameters may be indicated semi-statically, dynamically, or semi-persistently. For example, the network node 510-a may transmit the second control message via a downlink control information, via a MAC message (e.g., a MAC control element), or an RRC message.

The repeater device 505 may relay signaling in accordance with the polarization parameters. For example, the repeater device 505 may relay signaling to the second network node 510-b based on the one or more polarization parameters. In some aspects, the repeater device 505 may relay signaling from the network node 510-a to the network node 510-b. For example, the repeater device may receive signaling from the network node 510-a at 535. The repeater device 505 may apply an amplification gain to the received signaling at 540, and the repeater device 505 may transmit (e.g., forward) the signaling to the network node 510-b at 545.

In an example, the repeater device 505 may be operating as a TDD repeater. The repeater device 505 may receive signaling using the first polarization based on the second control message. For example, the repeater device 505 may receive the signaling using antenna elements configured for the first polarization based on the second control message. The repeater device 505 may forward the received signal after amplification on a different polarization. For example, the repeater device 505 may transmit, to the network node 510-b, the signaling using the second polarization based on the second control message. By using orthogonal polarizations for the transmission and reception, the repeater device 505 may mitigate echo interference, as reflections may not be picked up at receive antennas based on the orthogonal or incompatible polarization of the transmit antennas.

In an example, the repeater device 505 may be operating as a bidirectional repeater. The repeater device 505 may receive a first signaling (e.g., a first message) in the first direction using the first polarization and transmit the first message in the first direction to the second network node 510-b using the first polarization. The repeater device 505 may receive a second signaling (e.g., a second message) from the network node 510-b in the second direction using the second polarization. The repeater device may transmit the second message in the second direction using the polarization. By using orthogonal polarizations for the first direction and the second direction, the repeater device 505 may mitigate cross-link interference and echo interference, as reflections may not be picked up at receive antennas used for signaling in the other direction based on the orthogonal polarization of the transmit antennas and receive antennas.

In some aspects, the repeater device 505 may select the one or more polarization parameters. The repeater device 505 may measure one or more channels at the repeater device based on the set of multiple polarizations of a set of multiple antenna panels at the repeater device to produce measurement information. For example, the repeater device 505 may perform the measurements at 515 to obtain an echo interference measurement, a cross-link interference measurement, a wireless backhaul channel measurement, or a wireless access channel measurement. In some aspects, the selection at 530 may be an example of an autonomous polarization selection or an autonomous polarization selection procedure described herein.

At 530, the repeater device 505 may select one or more polarization parameters for relaying signaling to a network node (e.g., the network node 510-b) based on polarization measurement information. In some cases, the measurement information includes the polarization measurement information. The repeater device 505 may relay signaling to the network node based on the one or more polarization parameters.

In some aspects, if the repeater device 505 selects the one or more polarization parameters, the selection may be based on a configuration or rules indicated by another entity, such as a control entity or a network node (e.g., the network node 510-a). The repeater device 505 may select the one or more polarization parameters based on thresholds, resources in which autonomous configuration selection (e.g., autonomous polarization selection) is authorized, or a set of supported configurations.

For example, the repeater device 505 may select the one or more polarization parameters based on the polarization measurement information satisfying a threshold. In some cases, the repeater device 505 may receive, from a control entity, a control message indicating the threshold. Additionally, or alternatively, the repeater device 505 may select the one or more polarization parameters for a set of resources enabled for autonomous polarization selection. In some aspects, the repeater device 505 may receive, from the control entity, a control message indicating the set of resources enabled for autonomous polarization selection. Additionally, or alternatively, the repeater device 505 may select the one or more polarization parameters from multiple sets of polarization parameters supported for autonomous polarization selection. In some aspects, the repeater device 505 may receive, from the control entity, a control message indicating the multiple sets of polarization parameters supported for autonomous polarization selection.

In some aspects, if the repeater device 505 selects the one or more polarization parameters, the repeater device 505 may indicate the selected polarization parameters to remote entities for which the repeater device 505 relays signaling. For example, the repeater device 505 may transmit, to the network node 510-a, a control message indicating the one or more polarization parameters.

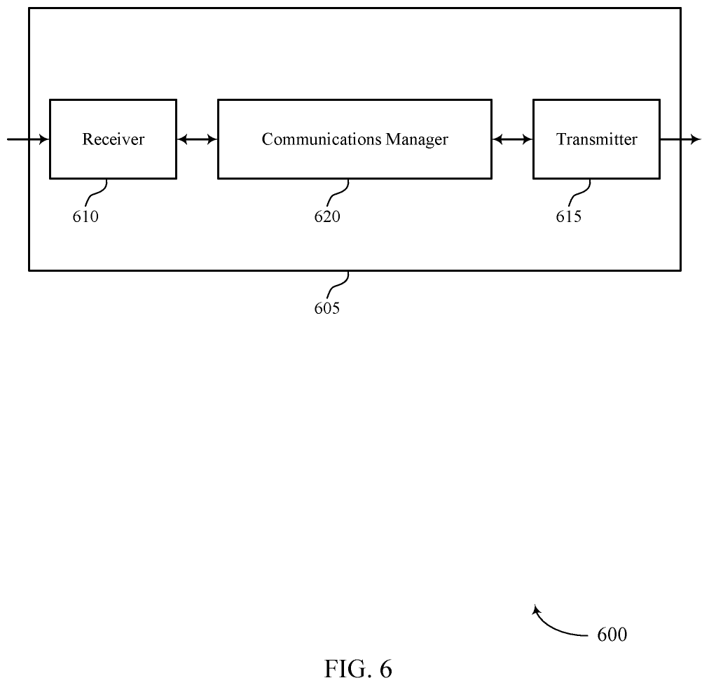

FIG. 6 shows a block diagram 600 of a device 605 that supports techniques for handling self-oscillation at repeaters in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for handling self-oscillation at repeaters). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for handling self-oscillation at repeaters). In some aspects, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for handling self-oscillation at repeaters as described herein. For example, the communications manager 620, the receiver 610, the transmitter 615, or various combinations or components thereof may support a method for performing one or more of the functions described herein.

In some aspects, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a repeater device in accordance with aspects as disclosed herein. For example, the communications manager 620 may be configured as or otherwise support a means for transmitting, to a first network node, a first control message indicating capability information indicative of one or more capabilities of the repeater device and polarization measurement information at the repeater device. The communications manager 620 may be configured as or otherwise support a means for receiving, from the first network node, a second control message indicating one or more polarization parameters based on the capability information and the polarization measurement information. The communications manager 620 may be configured as or otherwise support a means for relaying signaling to a second network node based on the one or more polarization parameters.

Additionally, or alternatively, the communications manager 620 may support wireless communications at a first network node in accordance with aspects as disclosed herein. For example, the communications manager 620 may be configured as or otherwise support a means for receiving, from a repeater device, a first control message indicating a capability information indicative of one or more capabilities of the repeater device and polarization measurement information at the repeater device. The communications manager 620 may be configured as or otherwise support a means for transmitting, to the repeater device, a second control message indicating one or more polarization parameters for the repeater device to relay signaling to a second network node based on the capability information and the polarization measurement information.

Additionally, or alternatively, the communications manager 620 may support wireless communications at a repeater device in accordance with aspects as disclosed herein. For example, the communications manager 620 may be configured as or otherwise support a means for measuring one or more channels at the repeater device based on a set of multiple polarizations of a set of multiple antenna panels at the repeater device to produce measurement information. The communications manager 620 may be configured as or otherwise support a means for selecting one or more polarization parameters for relaying signaling to a network node based on polarization measurement information, where the measurement information includes the polarization measurement information. The communications manager 620 may be configured as or otherwise support a means for relaying the signaling to the network node based on the one or more polarization parameters.

By including or configuring the communications manager 620 in accordance with aspects as described herein, the device 605 (e.g., a processor controlling or otherwise coupled with the receiver 610, the transmitter 615, the communications manager 620, or a combination thereof) may support techniques for more efficient utilization of communication resources based on mitigating interference and increased power amplification for relaying signaling.

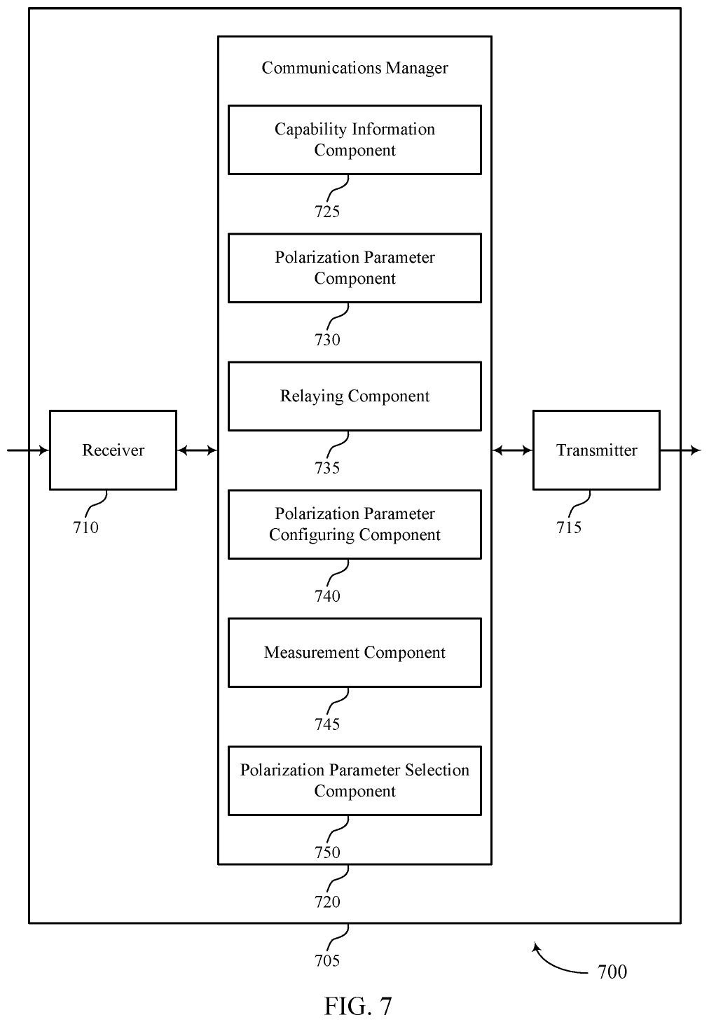

FIG. 7 shows a block diagram 700 of a device 705 that supports techniques for handling self-oscillation at repeaters in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for handling self-oscillation at repeaters). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for handling self-oscillation at repeaters). In some aspects, the transmitter 715 may be co-located with a receiver 710 in a transceiver module. The transmitter 715 may utilize a single antenna or a set of multiple antennas.

The device 705, or various components thereof, may be an example of means for performing various aspects of techniques for handling self-oscillation at repeaters as described herein. For example, the communications manager 720 may include a capability information component 725, a polarization parameter component 730, a relaying component 735, a polarization parameter configuring component 740, a measurement component 745, a polarization parameter selection component 750, or any combination thereof. The communications manager 720 may be an example of aspects of a communications manager 620 as described herein. In some aspects, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a repeater device in accordance with aspects as disclosed herein. The capability information component 725 may be configured as or otherwise support a means for transmitting, to a first network node, a first control message indicating capability information indicative of one or more capabilities of the repeater device and polarization measurement information at the repeater device. The polarization parameter component 730 may be configured as or otherwise support a means for receiving, from the first network node, a second control message indicating one or more polarization parameters based on the capability information and the polarization measurement information. The relaying component 735 may be configured as or otherwise support a means for relaying signaling to a second network node based on the one or more polarization parameters.

Additionally, or alternatively, the communications manager 720 may support wireless communications at a first network node in accordance with aspects as disclosed herein. The capability information component 725 may be configured as or otherwise support a means for receiving, from a repeater device, a first control message indicating a capability information indicative of one or more capabilities of the repeater device and polarization measurement information at the repeater device. The polarization parameter configuring component 740 may be configured as or otherwise support a means for transmitting, to the repeater device, a second control message indicating one or more polarization parameters for the repeater device to relay signaling to a second network node based on the capability information and the polarization measurement information.

Additionally, or alternatively, the communications manager 720 may support wireless communications at a repeater device in accordance with aspects as disclosed herein. The measurement component 745 may be configured as or otherwise support a means for measuring one or more channels at the repeater device based on a set of multiple polarizations of a set of multiple antenna panels at the repeater device to produce measurement information. The polarization parameter selection component 750 may be configured as or otherwise support a means for selecting one or more polarization parameters for relaying signaling to a network node based on polarization measurement information, where the measurement information includes the polarization measurement information. The relaying component 735 may be configured as or otherwise support a means for relaying the signaling to the network node based on the one or more polarization parameters.

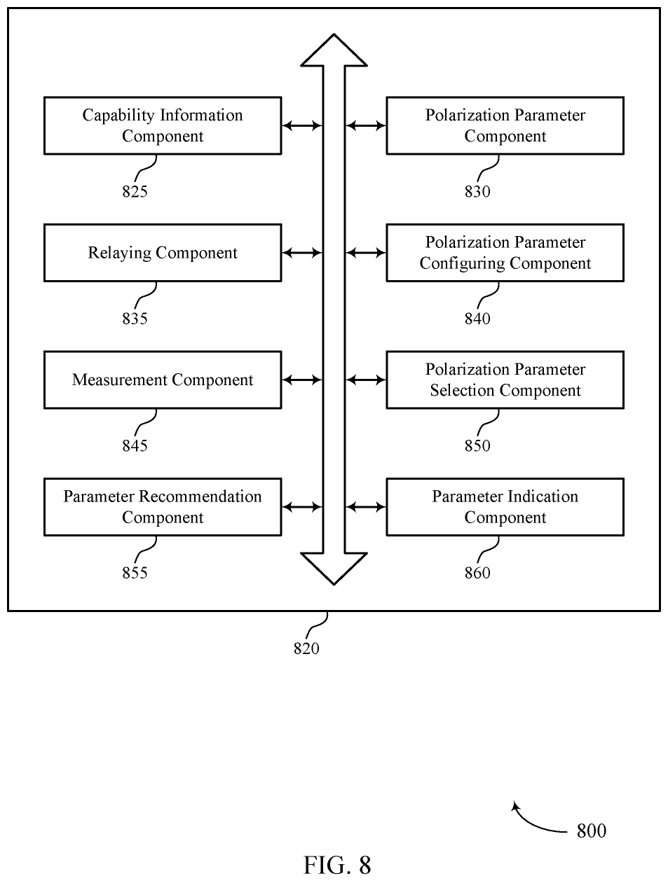

FIG. 8 shows a block diagram 800 of a communications manager 820 that supports techniques for handling self-oscillation at repeaters in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for handling self-oscillation at repeaters as described herein. For example, the communications manager 820 may include a capability information component 825, a polarization parameter component 830, a relaying component 835, a polarization parameter configuring component 840, a measurement component 845, a polarization parameter selection component 850, a parameter recommendation component 855, a parameter indication component 860, or any combination thereof. Each of these components may communicate, directly or indirectly, with one another (e.g., via one or more buses).

The communications manager 820 may support wireless communications at a repeater device in accordance with aspects as disclosed herein. The capability information component 825 may be configured as or otherwise support a means for transmitting, to a first network node, a first control message indicating capability information indicative of one or more capabilities of the repeater device and polarization measurement information at the repeater device. The polarization parameter component 830 may be configured as or otherwise support a means for receiving, from the first network node, a second control message indicating one or more polarization parameters based on the capability information and the polarization measurement information. The relaying component 835 may be configured as or otherwise support a means for relaying signaling to a second network node based on the one or more polarization parameters.

In some aspects, the one or more polarization parameters indicate a first polarization for receiving the signaling and a second polarization for transmitting the signaling.

In some aspects, to support relaying the signaling, the relaying component 835 may be configured as or otherwise support a means for receiving the signaling using the first polarization based on the second control message. In some aspects, to support relaying the signaling, the relaying component 835 may be configured as or otherwise support a means for transmitting, to the second network node, the signaling using the second polarization based on the second control message.

In some aspects, the one or more polarization parameters indicate a first polarization for a first direction and a second polarization for a second direction.

In some aspects, to support relaying the signaling, the relaying component 835 may be configured as or otherwise support a means for receiving a first message in the first direction using the first polarization. In some aspects, to support relaying the signaling, the relaying component 835 may be configured as or otherwise support a means for transmitting the first message in the first direction to the second network node using the first polarization. In some aspects, to support relaying the signaling, the relaying component 835 may be configured as or otherwise support a means for receiving a second message from the second network node in the second direction using the second polarization. In some aspects, to support relaying the signaling, the relaying component 835 may be configured as or otherwise support a means for transmitting the second message in the second direction using the second polarization.

In some aspects, the one or more polarization parameters include a first set of polarization parameters for a first set of time and frequency resources and a second set of polarization parameters for a second set of time and frequency resources.

In some aspects, the first set of time and frequency resources includes a first passband, a first subband, or a first set of resource blocks, and the second set of time and frequency resources includes a second passband, a second subband, or a second set of resource blocks.

In some aspects, the one or more polarization parameters include a first set of polarization parameters for a first set of spatial beams and a second set of polarization parameters for a second set of spatial beams.

In some aspects, to support relaying the signaling, the relaying component 835 may be configured as or otherwise support a means for relaying the signaling includes relaying the signaling based on the set of power parameters.

In some aspects, the measurement component 845 may be configured as or otherwise support a means for measuring an echo interference at the repeater device based on transmission at the repeater device, where the first control message includes a first echo interference measurement for time division duplexed relaying or second echo interference measurement for bidirectional relaying.

In some aspects, the measurement component 845 may be configured as or otherwise support a means for measuring a wireless backhaul channel using each polarization of a set of multiple polarizations at the repeater device to produce a wireless backhaul channel measurement, where the polarization measurement information includes the wireless backhaul channel measurement.

In some aspects, the measurement component 845 may be configured as or otherwise support a means for measuring a wireless access channel using each polarization of a set of multiple polarizations at the repeater device to produce a wireless access channel measurement, where the polarization measurement information includes the wireless access channel measurement.

In some aspects, the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

In some aspects, the parameter recommendation component 855 may be configured as or otherwise support a means for transmitting an indication of a recommendation for the one or more polarization parameters, where the second control message indicating the one or more polarization parameters is based on the recommendation.

In some aspects, the control signaling indicates a first set of time resources, a second set of frequency resources, or a third set of spatial resources, for the recommendation for the one or more polarization parameters.

In some aspects, to support receiving the second control message, the polarization parameter component 830 may be configured as or otherwise support a means for receiving the second control message via a downlink control information message.

In some aspects, to support receiving the second control message, the polarization parameter component 830 may be configured as or otherwise support a means for receiving the second control message via a medium access control message or a radio resource control message.

In some aspects, the first network node is a first UE or a first network entity, and the second network node is a second UE or a second network entity.

Additionally, or alternatively, the communications manager 820 may support wireless communications at a first network node in accordance with aspects as disclosed herein. In some aspects, the capability information component 825 may be configured as or otherwise support a means for receiving, from a repeater device, a first control message indicating a capability information indicative of one or more capabilities of the repeater device and polarization measurement information at the repeater device. The polarization parameter configuring component 840 may be configured as or otherwise support a means for transmitting, to the repeater device, a second control message indicating one or more polarization parameters for the repeater device to relay signaling to a second network node based on the capability information and the polarization measurement information.

In some aspects, the one or more polarization parameters indicate a first polarization for the repeater device to receive the signaling and a second polarization for the repeater device to transmit the signaling.

In some aspects, the one or more polarization parameters indicate a first polarization for a first direction and a second polarization for a second direction.

In some aspects, the one or more polarization parameters include a first set of polarization parameters for a first set of time and frequency resources and a second set of polarization parameters for a second set of time and frequency resources.

In some aspects, the first set of time and frequency resources includes a first passband, a first subband, or a first set of resource blocks, and the second set of time and frequency resources includes a second passband, a second subband, or a second set of resource blocks.

In some aspects, the one or more polarization parameters include a first set of polarization parameters for a first set of spatial beams and a second set of polarization parameters for a second set of spatial beams.

In some aspects, the second control message indicates a set of power parameters for the repeater device to relay the signaling.

In some aspects, the polarization measurement information indicates an echo interference at the repeater device. In some aspects, the polarization measurement information includes a first echo interference measurement for time division duplexed relaying or a second echo interference measurement for bidirectional relaying.

In some aspects, the polarization measurement information indicates a wireless backhaul channel measurement for each polarization of a set of multiple polarizations at the repeater device.

In some aspects, the polarization measurement information indicates a wireless access channel measurement for each polarization of a set of multiple polarizations at the repeater device.

In some aspects, the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

In some aspects, the parameter recommendation component 855 may be configured as or otherwise support a means for receiving control signaling indicating a recommendation for the one or more polarization parameters, where the second control message indicating the one or more polarization parameters is based on the recommendation.

In some aspects, the control signaling indicates a first set of time resources, a second set of frequency resources, or a third set of spatial resources, for the recommendation for the one or more polarization parameters.

In some aspects, to support transmitting the second control message, the polarization parameter configuring component 840 may be configured as or otherwise support a means for transmitting the second control message via a downlink control information message.

In some aspects, to support transmitting the second control message, the polarization parameter configuring component 840 may be configured as or otherwise support a means for transmitting the second control message via a medium access control message or a radio resource control message.

Additionally, or alternatively, the communications manager 820 may support wireless communications at a repeater device in accordance with aspects as disclosed herein. The measurement component 845 may be configured as or otherwise support a means for measuring one or more channels at the repeater device based on a set of multiple polarizations of a set of multiple antenna panels at the repeater device to produce measurement information. The polarization parameter selection component 850 may be configured as or otherwise support a means for selecting one or more polarization parameters for relaying signaling to a network node based on polarization measurement information, where the measurement information includes the polarization measurement information. In some aspects, the relaying component 835 may be configured as or otherwise support a means for relaying the signaling to the network node based on the one or more polarization parameters.

In some aspects, to support selecting the one or more polarization parameters, the polarization parameter selection component 850 may be configured as or otherwise support a means for selecting a first polarization for receiving the signaling and a second polarization for transmitting the signaling.

In some aspects, to support relaying the signaling, the relaying component 835 may be configured as or otherwise support a means for receiving the signaling using the first polarization based on the one or more polarization parameters. In some aspects, to support relaying the signaling, the relaying component 835 may be configured as or otherwise support a means for transmitting, to the network node, the signaling using the second polarization based on the one or more polarization parameters.

In some aspects, to support selecting the one or more polarization parameters, the polarization parameter selection component 850 may be configured as or otherwise support a means for selecting a first polarization for a first direction of the signaling and a second polarization for a second direction of the signaling.

In some aspects, to support relaying the signaling, the relaying component 835 may be configured as or otherwise support a means for relaying a first message in the first direction using the first polarization based on the one or more polarization parameters. In some aspects, to support relaying the signaling, the relaying component 835 may be configured as or otherwise support a means for relaying a second message in the second direction using the second polarization based on the one or more polarization parameters.

In some aspects, to support selecting the one or more polarization parameters, the polarization parameter selection component 850 may be configured as or otherwise support a means for selecting the one or more polarization parameters based on the polarization measurement information satisfying a threshold.

In some aspects, the polarization measurement information includes an echo interference measurement at the repeater device based on transmission at the repeater device. In some aspects, the echo interference measurement is based on time division duplexed relaying or bidirectional relaying.

In some aspects, the polarization measurement information includes a wireless backhaul channel measurement of a wireless backhaul channel with a network node for each polarization of the set of multiple polarizations.

In some aspects, the polarization measurement information includes a wireless access channel measurement of a wireless access channel with a network entity or a UE for each polarization of the set of multiple polarizations.

In some aspects, the polarization parameter selection component 850 may be configured as or otherwise support a means for receiving, from a control entity, a control message indicating the threshold.

In some aspects, to support selecting the one or more polarization parameters, the polarization parameter selection component 850 may be configured as or otherwise support a means for selecting the one or more polarization parameters for a set of resources enabled for autonomous polarization selection.

In some aspects, the polarization parameter selection component 850 may be configured as or otherwise support a means for receiving, from a control entity, a control message indicating the set of resources enabled for autonomous polarization selection.

In some aspects, to support selecting the one or more polarization parameters, the polarization parameter selection component 850 may be configured as or otherwise support a means for selecting the one or more polarization parameters from a set of multiple sets of polarization parameters supported for autonomous polarization selection.

In some aspects, the polarization parameter selection component 850 may be configured as or otherwise support a means for receiving, from a control entity, a control message indicating the set of multiple sets of polarization parameters supported for autonomous polarization selection.

In some aspects, the parameter indication component 860 may be configured as or otherwise support a means for transmitting, to the network node, a control message indicating the one or more polarization parameters.

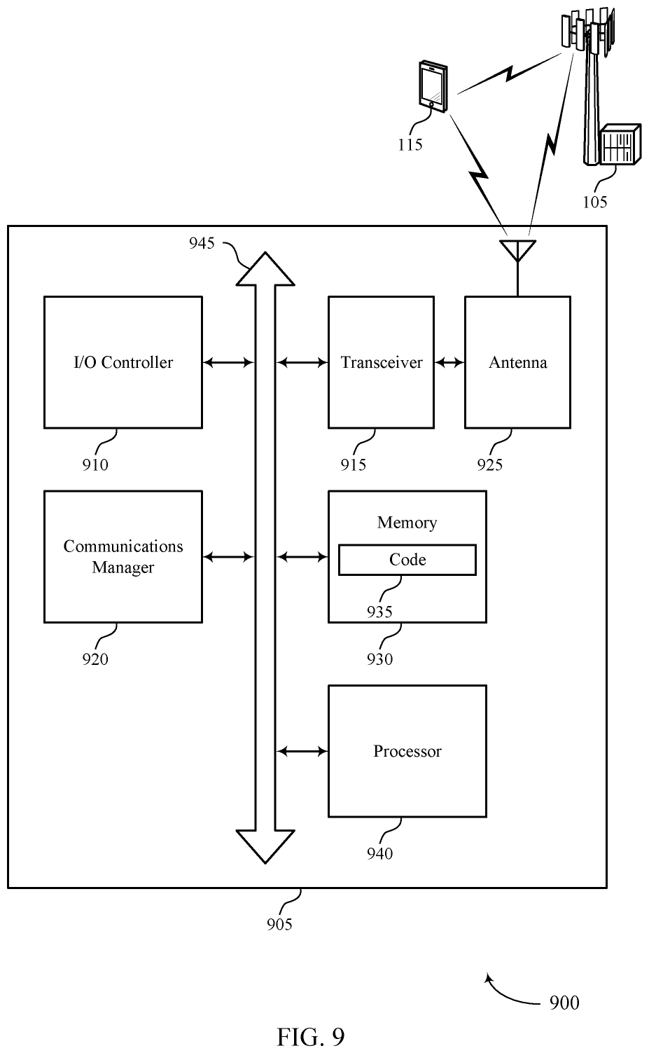

FIG. 9 shows a diagram of a system 900 including a device 905 that supports techniques for handling self-oscillation at repeaters in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for handling self-oscillation at repeaters). For example, the device 905 or a component of the device 905 may include a processor 940 and memory 930 coupled with or to the processor 940, the processor 940 and memory 930 configured to perform various functions described herein.

The communications manager 920 may support wireless communications at a repeater device in accordance with aspects as disclosed herein. For example, the communications manager 920 may be configured as or otherwise support a means for transmitting, to a first network node, a first control message indicating capability information indicative of one or more capabilities of the repeater device and polarization measurement information at the repeater device. The communications manager 920 may be configured as or otherwise support a means for receiving, from the first network node, a second control message indicating one or more polarization parameters based on the capability information and the polarization measurement information. The communications manager 920 may be configured as or otherwise support a means for relaying signaling to a second network node based on the one or more polarization parameters.

Additionally, or alternatively, the communications manager 920 may support wireless communications at a first network node in accordance with aspects as disclosed herein. For example, the communications manager 920 may be configured as or otherwise support a means for receiving, from a repeater device, a first control message indicating a capability information indicative of one or more capabilities of the repeater device and polarization measurement information at the repeater device. The communications manager 920 may be configured as or otherwise support a means for transmitting, to the repeater device, a second control message indicating one or more polarization parameters for the repeater device to relay signaling to a second network node based on the capability information and the polarization measurement information.

Additionally, or alternatively, the communications manager 920 may support wireless communications at a repeater device in accordance with aspects as disclosed herein. For example, the communications manager 920 may be configured as or otherwise support a means for measuring one or more channels at the repeater device based on a set of multiple polarizations of a set of multiple antenna panels at the repeater device to produce measurement information. The communications manager 920 may be configured as or otherwise support a means for selecting one or more polarization parameters for relaying signaling to a network node based on polarization measurement information, where the measurement information includes the polarization measurement information. The communications manager 920 may be configured as or otherwise support a means for relaying the signaling to the network node based on the one or more polarization parameters.

By including or configuring the communications manager 920 in accordance with aspects as described herein, the device 905 may support techniques for reduced interference, such as clutter interference or cross-link interference. Additionally, the techniques described herein may provide more efficient utilization of communication resources based on mitigating interference and increased power amplification for signal relaying.

In some aspects, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some aspects, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for handling self-oscillation at repeaters as described herein, or the processor 940 and the memory 930 may be otherwise configured to perform or support such operations.

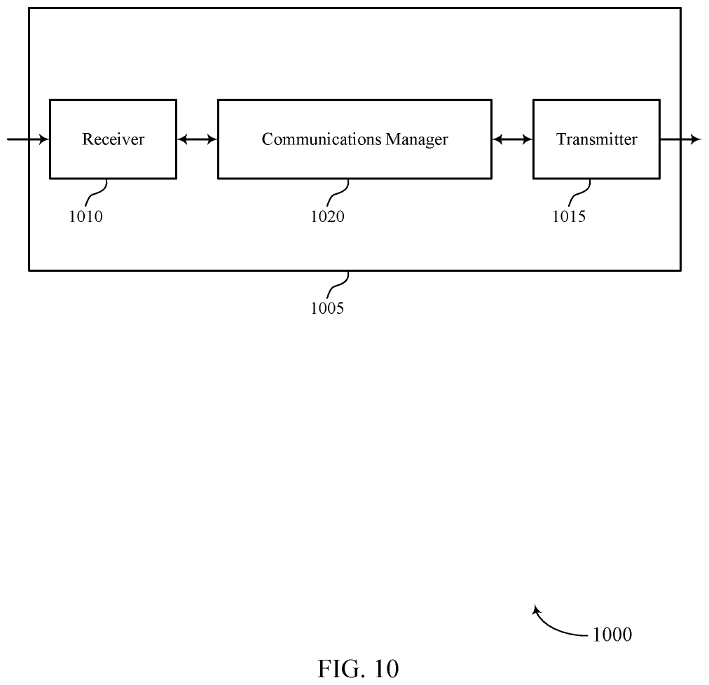

FIG. 10 shows a block diagram 1000 of a device 1005 that supports techniques for handling self-oscillation at repeaters in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some aspects, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some aspects, the transmitter 1015 and the receiver 1010 may be co-located in a transceiver, which may include or be coupled with a modem.

The communications manager 1020, the receiver 1010, the transmitter 1015, or various combinations thereof or various components thereof may be aspects of means for performing various aspects of techniques for handling self-oscillation at repeaters as described herein. For example, the communications manager 1020, the receiver 1010, the transmitter 1015, or various combinations or components thereof may support a method for performing one or more of the functions described herein.

In some aspects, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first network node in accordance with aspects as disclosed herein. For example, the communications manager 1020 may be configured as or otherwise support a means for receiving, from a repeater device, a first control message indicating a capability information indicative of one or more capabilities of the repeater device and polarization measurement information at the repeater device. The communications manager 1020 may be configured as or otherwise support a means for transmitting, to the repeater device, a second control message indicating one or more polarization parameters for the repeater device to relay signaling to a second network node based on the capability information and the polarization measurement information.

By including or configuring the communications manager 1020 in accordance with aspects as described herein, the device 1005 (e.g., a processor controlling or otherwise coupled with the receiver 1010, the transmitter 1015, the communications manager 1020, or a combination thereof) may support techniques for more efficient utilization of communication resources based on mitigating interference and increased power amplification for signal relaying.

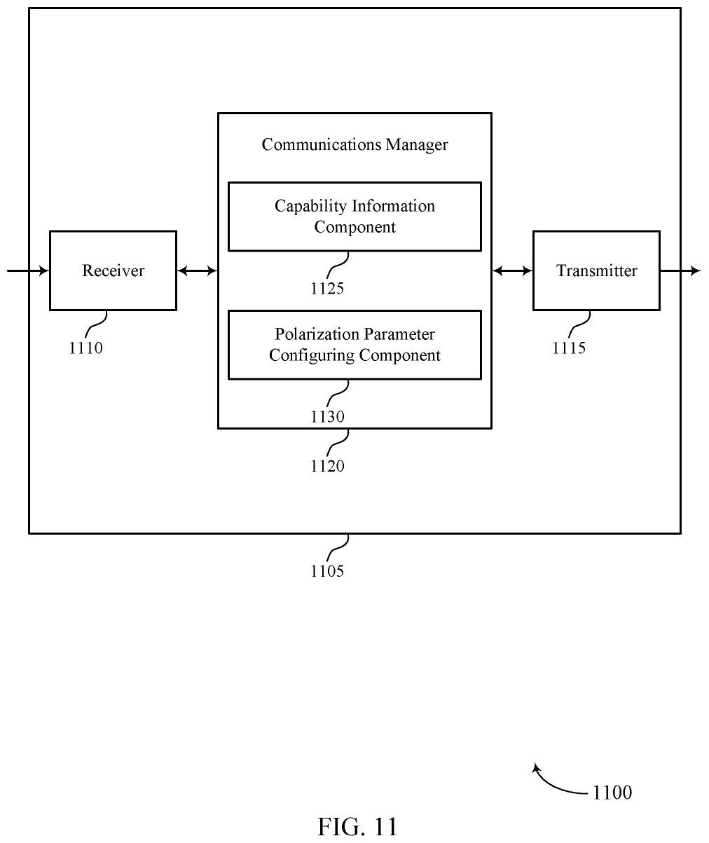

FIG. 11 shows a block diagram 1100 of a device 1105 that supports techniques for handling self-oscillation at repeaters in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some aspects, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some aspects, the transmitter 1115 and the receiver 1110 may be co-located in a transceiver, which may include or be coupled with a modem.

The device 1105, or various components thereof, may be an example of means for performing various aspects of techniques for handling self-oscillation at repeaters as described herein. For example, the communications manager 1120 may include a capability information component 1125 a polarization parameter configuring component 1130, or any combination thereof. The communications manager 1120 may be an example of aspects of a communications manager 1020 as described herein. In some aspects, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a first network node in accordance with aspects as disclosed herein. The capability information component 1125 may be configured as or otherwise support a means for receiving, from a repeater device, a first control message indicating a capability information indicative of one or more capabilities of the repeater device and polarization measurement information at the repeater device. The polarization parameter configuring component 1130 may be configured as or otherwise support a means for transmitting, to the repeater device, a second control message indicating one or more polarization parameters for the repeater device to relay signaling to a second network node based on the capability information and the polarization measurement information.

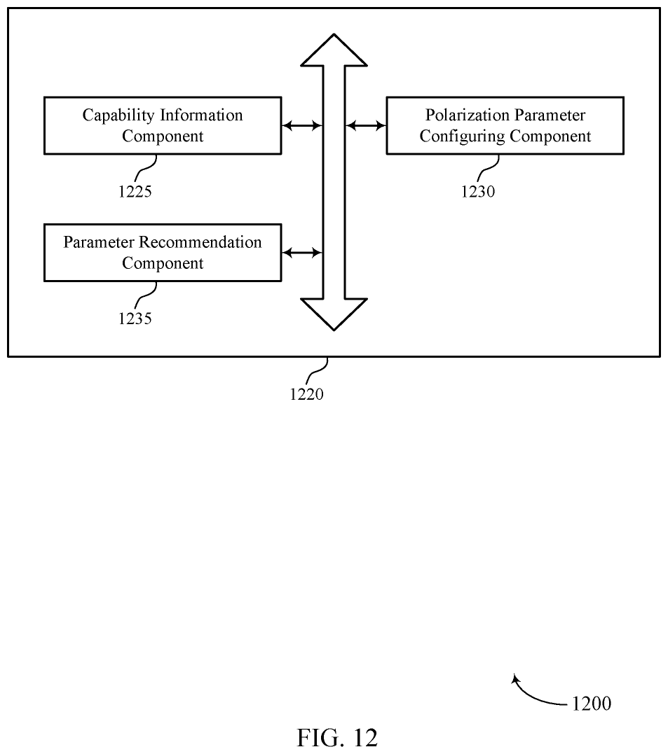

FIG. 12 shows a block diagram 1200 of a communications manager 1220 that supports techniques for handling self-oscillation at repeaters in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for handling self-oscillation at repeaters as described herein. For example, the communications manager 1220 may include a capability information component 1225, a polarization parameter configuring component 1230, a parameter recommendation component 1235, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a first network node in accordance with aspects as disclosed herein. The capability information component 1225 may be configured as or otherwise support a means for receiving, from a repeater device, a first control message indicating a capability information indicative of one or more capabilities of the repeater device and polarization measurement information at the repeater device. The polarization parameter configuring component 1230 may be configured as or otherwise support a means for transmitting, to the repeater device, a second control message indicating one or more polarization parameters for the repeater device to relay signaling to a second network node based on the capability information and the polarization measurement information.

In some aspects, the one or more polarization parameters indicate a first polarization for the repeater device to receive the signaling and a second polarization for the repeater device to transmit the signaling.

In some aspects, the one or more polarization parameters indicate a first polarization for a first direction and a second polarization for a second direction.

In some aspects, the one or more polarization parameters include a first set of polarization parameters for a first set of time and frequency resources and a second set of polarization parameters for a second set of time and frequency resources.

In some aspects, the first set of time and frequency resources includes a first passband, a first subband, or a first set of resource blocks, and the second set of time and frequency resources includes a second passband, a second subband, or a second set of resource blocks.

In some aspects, the one or more polarization parameters include a first set of polarization parameters for a first set of spatial beams and a second set of polarization parameters for a second set of spatial beams.

In some aspects, the second control message indicates a set of power parameters for the repeater device to relay the signaling.

In some aspects, the polarization measurement information indicates an echo interference at the repeater device. In some aspects, the polarization measurement information includes a first echo interference measurement for time division duplexed relaying or a second echo interference measurement for bidirectional relaying.

In some aspects, the polarization measurement information indicates a wireless backhaul channel measurement for each polarization of a set of multiple polarizations at the repeater device.

In some aspects, the polarization measurement information indicates a wireless access channel measurement for each polarization of a set of multiple polarizations at the repeater device.

In some aspects, the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

In some aspects, the parameter recommendation component 1235 may be configured as or otherwise support a means for receiving control signaling indicating a recommendation for the one or more polarization parameters, where the second control message indicating the one or more polarization parameters is based on the recommendation.

In some aspects, the control signaling indicates a first set of time resources, a second set of frequency resources, or a third set of spatial resources, for the recommendation for the one or more polarization parameters.

In some aspects, to support transmitting the second control message, the polarization parameter configuring component 1230 may be configured as or otherwise support a means for transmitting the second control message via a downlink control information message.

In some aspects, to support transmitting the second control message, the polarization parameter configuring component 1230 may be configured as or otherwise support a means for transmitting the second control message via a medium access control message or a radio resource control message.

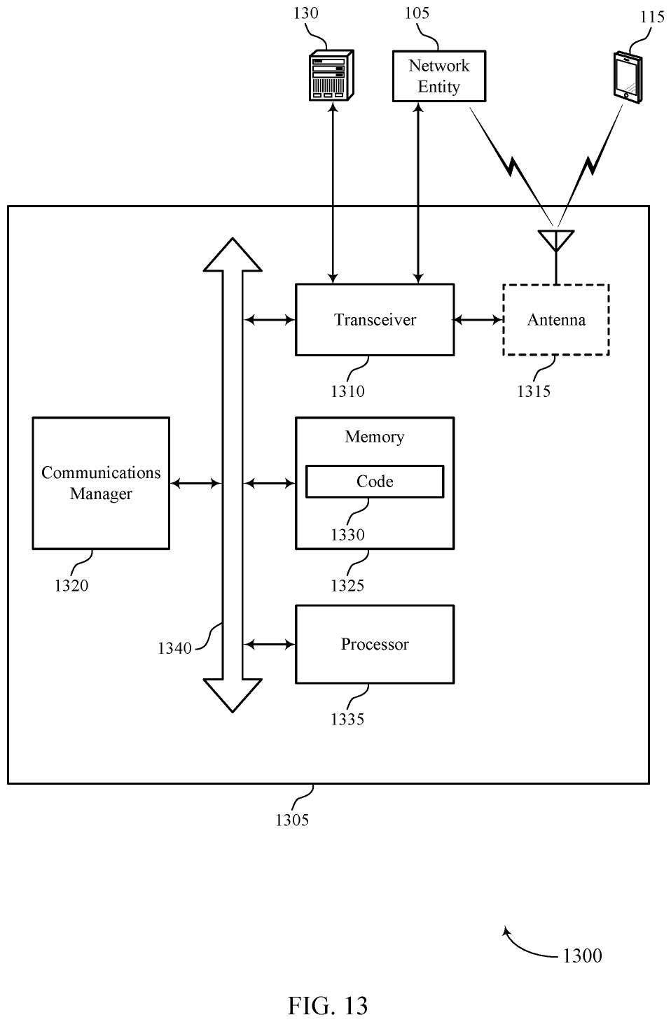

FIG. 13 shows a diagram of a system 1300 including a device 1305 that supports techniques for handling self-oscillation at repeaters in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some aspects, the transceiver 1310 may include a wired transceiver and may communicate bi-directionally with another wired transceiver. Additionally, or alternatively, in some aspects, the transceiver 1310 may include a wireless transceiver and may communicate bi-directionally with another wireless transceiver. In some aspects, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some aspects, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for handling self-oscillation at repeaters). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1340 may support communications of (e.g., within) a protocol layer of a protocol stack. In some aspects, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some aspects, the communications manager 1320 may manage aspects of communications with a core network 130 (e.g., via one or more wired or wireless backhaul links). For example, the communications manager 1320 may manage the transfer of data communications for client devices, such as one or more UEs 115. In some aspects, the communications manager 1320 may manage communications with other network entities 105, and may include a controller or scheduler for controlling communications with UEs 115 in cooperation with other network entities 105. In some aspects, the communications manager 1320 may support an X2 interface within an LTE/LTE-A wireless communications network technology to provide communication between network entities 105.

The communications manager 1320 may support wireless communications at a first network node in accordance with aspects as disclosed herein. For example, the communications manager 1320 may be configured as or otherwise support a means for receiving, from a repeater device, a first control message indicating a capability information indicative of one or more capabilities of the repeater device and polarization measurement information at the repeater device. The communications manager 1320 may be configured as or otherwise support a means for transmitting, to the repeater device, a second control message indicating one or more polarization parameters for the repeater device to relay signaling to a second network node based on the capability information and the polarization measurement information.

By including or configuring the communications manager 1320 in accordance with aspects as described herein, the device 1305 may support techniques for reduced interference, such as clutter interference or cross-link interference. Additionally, the techniques described herein may provide more efficient utilization of communication resources based on mitigating interference and increased power amplification for signal relaying.

In some aspects, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some aspects, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for handling self-oscillation at repeaters as described herein, or the processor 1335 and the memory 1325 may be otherwise configured to perform or support such operations.

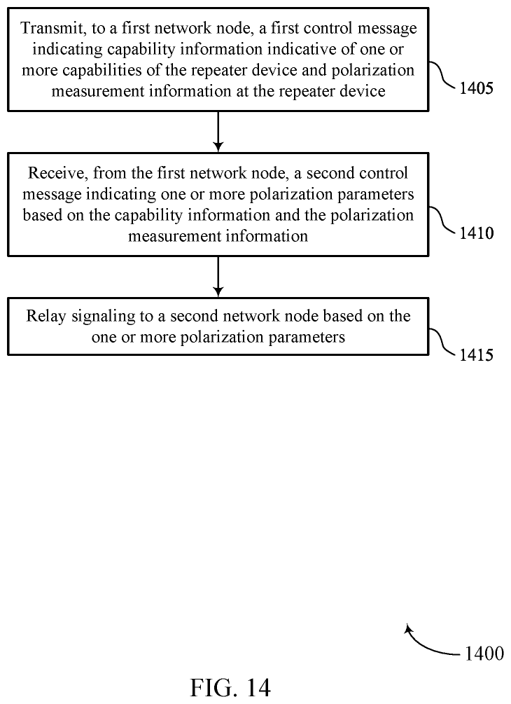

FIG. 14 shows a flowchart illustrating a method 1400 that supports techniques for handling self-oscillation at repeaters in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1405, the method may include transmitting, to a first network node, a first control message indicating capability information indicative of one or more capabilities of the repeater device and polarization measurement information at the repeater device. The operations of 1405 may be performed in accordance with examples as disclosed herein. In some aspects, aspects of the operations of 1405 may be performed by a capability information component 825 as described with reference to FIG. 8.

At 1410, the method may include receiving, from the first network node, a second control message indicating one or more polarization parameters based on the capability information and the polarization measurement information. The operations of 1410 may be performed in accordance with examples as disclosed herein. In some aspects, aspects of the operations of 1410 may be performed by a polarization parameter component 830 as described with reference to FIG. 8.

At 1415, the method may include relaying signaling to a second network node based on the one or more polarization parameters. The operations of 1415 may be performed in accordance with examples as disclosed herein. In some aspects, aspects of the operations of 1415 may be performed by a relaying component 835 as described with reference to FIG. 8.

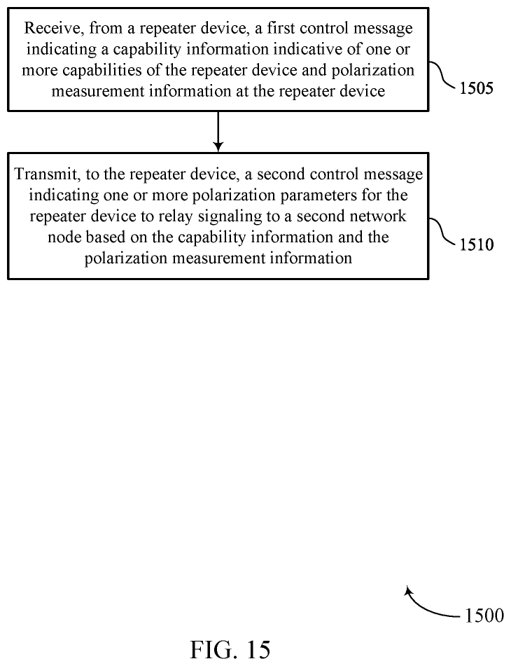

FIG. 15 shows a flowchart illustrating a method 1500 that supports techniques for handling self-oscillation at repeaters in accordance with one or more aspects of the present disclosure. The operations of the method 1500 may be implemented by a UE or a network entity or its components as described herein. For example, the operations of the method 1500 may be performed by a UE 115 as described with reference to FIGS. 1 through 9 or a network entity as described with reference to FIGS. 1 through 5 and 10 through 13. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include receiving, from a repeater device, a first control message indicating a capability information indicative of one or more capabilities of the repeater device and polarization measurement information at the repeater device. The operations of 1505 may be performed in accordance with examples as disclosed herein. In some aspects, aspects of the operations of 1505 may be performed by a capability information component 825 or a capability information component 1225 as described with reference to FIGS. 8 and 12.

At 1510, the method may include transmitting, to the repeater device, a second control message indicating one or more polarization parameters for the repeater device to relay signaling to a second network node based on the capability information and the polarization measurement information. The operations of 1510 may be performed in accordance with examples as disclosed herein. In some aspects, aspects of the operations of 1510 may be performed by a polarization parameter configuring component 840 or a polarization parameter configuring component 1230 as described with reference to FIGS. 8 and 12.

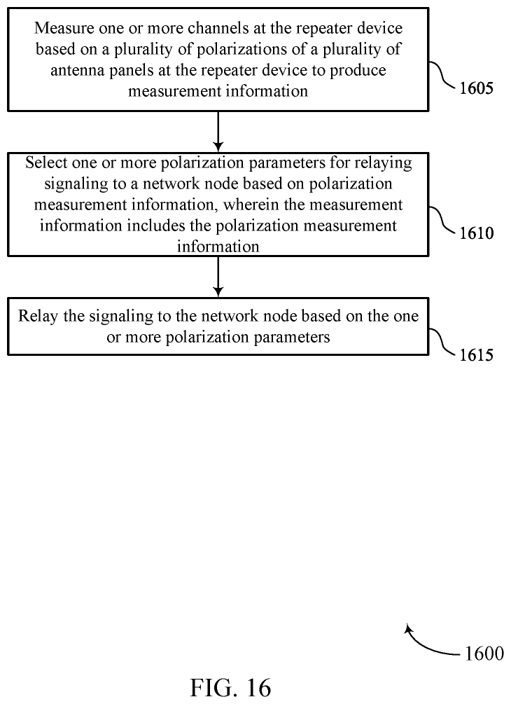

FIG. 16 shows a flowchart illustrating a method 1600 that supports techniques for handling self-oscillation at repeaters in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1605, the method may include measuring one or more channels at the repeater device based on a set of multiple polarizations of a set of multiple antenna panels at the repeater device to produce measurement information. The operations of 1605 may be performed in accordance with examples as disclosed herein. In some aspects, aspects of the operations of 1605 may be performed by a measurement component 845 as described with reference to FIG. 8.

At 1610, the method may include selecting one or more polarization parameters for relaying signaling to a network node based on polarization measurement information, where the measurement information includes the polarization measurement information. The operations of 1610 may be performed in accordance with examples as disclosed herein. In some aspects, aspects of the operations of 1610 may be performed by a polarization parameter selection component 850 as described with reference to FIG. 8.

At 1615, the method may include relaying the signaling to the network node based on the one or more polarization parameters. The operations of 1615 may be performed in accordance with examples as disclosed herein. In some aspects, aspects of the operations of 1615 may be performed by a relaying component 835 as described with reference to FIG. 8.

The following provides an overview of aspects of the present disclosure:

Aspect 1: A method for wireless communications at a repeater device, comprising: transmitting, to a first network node, a first control message indicating capability information indicative of one or more capabilities of the repeater device and polarization measurement information at the repeater device; receiving, from the first network node, a second control message indicating one or more polarization parameters based on the capability information and the polarization measurement information; and relaying signaling to a second network node based on the one or more polarization parameters.

Aspect 2: The method of aspect 1, wherein the one or more polarization parameters indicate a first polarization for receiving the signaling and a second polarization for transmitting the signaling.

Aspect 3: The method of aspect 2, wherein relaying the signaling further comprises: receiving the signaling using the first polarization based on the second control message; and transmitting, to the second network node, the signaling using the second polarization based on the second control message.

Aspect 4: The method of any of aspects 1 through 3, wherein the one or more polarization parameters indicate a first polarization for a first direction and a second polarization for a second direction.

Aspect 5: The method of aspect 4, wherein relaying the signaling further comprises: receiving a first message in the first direction using the first polarization; transmitting the first message in the first direction to the second network node using the first polarization; receiving a second message from the second network node in the second direction using the second polarization; and transmitting the second message in the second direction using the second polarization.

Aspect 6: The method of any of aspects 1 through 5, wherein the one or more polarization parameters include a first set of polarization parameters for a first set of time and frequency resources and a second set of polarization parameters for a second set of time and frequency resources.

Aspect 7: The method of aspect 6, wherein the first set of time and frequency resources includes a first passband, a first subband, or a first set of resource blocks, and the second set of time and frequency resources includes a second passband, a second subband, or a second set of resource blocks.

Aspect 8: The method of any of aspects 1 through 7, wherein the one or more polarization parameters include a first set of polarization parameters for a first set of spatial beams and a second set of polarization parameters for a second set of spatial beams.

Aspect 9: The method of any of aspects 1 through 8, wherein the second control message indicates a set of power parameters for relaying the signaling, wherein relaying the signaling comprises: relaying the signaling comprises relaying the signaling based on the set of power parameters.

Aspect 10: The method of any of aspects 1 through 9, further comprising: measuring an echo interference at the repeater device based on transmission at the repeater device, wherein the first control message includes a first echo interference measurement for time division duplexed relaying or second echo interference measurement for bidirectional relaying.

Aspect 11: The method of any of aspects 1 through 10, further comprising: measuring a wireless backhaul channel using each polarization of a plurality of polarizations at the repeater device to produce a wireless backhaul channel measurement, wherein the polarization measurement information includes the wireless backhaul channel measurement.

Aspect 12: The method of any of aspects 1 through 11, further comprising: measuring a wireless access channel using each polarization of a plurality of polarizations at the repeater device to produce a wireless access channel measurement, wherein the polarization measurement information includes the wireless access channel measurement.

Aspect 13: The method of any of aspects 1 through 12, wherein the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

Aspect 14: The method of any of aspects 1 through 13, further comprising: transmitting an indication of a recommendation for the one or more polarization parameters, wherein the second control message indicating the one or more polarization parameters is based on the recommendation.

Aspect 15: The method of aspect 14, wherein the control signaling indicates a first set of time resources, a second set of frequency resources, or a third set of spatial resources, for the recommendation for the one or more polarization parameters.

Aspect 16: The method of any of aspects 1 through 15, wherein receiving the second control message comprises: receiving the second control message via a downlink control information message.

Aspect 17: The method of any of aspects 1 through 16, wherein receiving the second control message comprises: receiving the second control message via a medium access control message or a radio resource control message.

Aspect 18: The repeater device of any of aspects 1 through 17, wherein the first network node is a first UE or a first network entity, and the second network node is a second UE or a second network entity.

Aspect 19: A method for wireless communications at a first network node, comprising: receiving, from a repeater device, a first control message indicating a capability information indicative of one or more capabilities of the repeater device and polarization measurement information at the repeater device; and transmitting, to the repeater device, a second control message indicating one or more polarization parameters for the repeater device to relay signaling to a second network node based on the capability information and the polarization measurement information.

Aspect 20: The method of aspect 19, wherein the one or more polarization parameters indicate a first polarization for the repeater device to receive the signaling and a second polarization for the repeater device to transmit the signaling.

Aspect 21: The method of any of aspects 19 through 20, wherein the one or more polarization parameters indicate a first polarization for a first direction and a second polarization for a second direction.

Aspect 22: The method of any of aspects 19 through 21, wherein the one or more polarization parameters include a first set of polarization parameters for a first set of time and frequency resources and a second set of polarization parameters for a second set of time and frequency resources.

Aspect 23: The method of aspect 22, wherein the first set of time and frequency resources includes a first passband, a first subband, or a first set of resource blocks, and the second set of time and frequency resources includes a second passband, a second subband, or a second set of resource blocks.

Aspect 24: The method of any of aspects 19 through 23, wherein the one or more polarization parameters include a first set of polarization parameters for a first set of spatial beams and a second set of polarization parameters for a second set of spatial beams.

Aspect 25: The method of any of aspects 19 through 24, wherein the second control message indicates a set of power parameters for the repeater device to relay the signaling.

Aspect 26: The method of any of aspects 19 through 25, wherein the polarization measurement information indicates an echo interference at the repeater device, the polarization measurement information includes a first echo interference measurement for time division duplexed relaying or a second echo interference measurement for bidirectional relaying.

Aspect 27: The method of any of aspects 19 through 26, wherein the polarization measurement information indicates a wireless backhaul channel measurement for each polarization of a plurality of polarizations at the repeater device.

Aspect 28: The method of any of aspects 19 through 27, wherein the polarization measurement information indicates a wireless access channel measurement for each polarization of a plurality of polarizations at the repeater device.

Aspect 29: The method of any of aspects 19 through 28, wherein the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

Aspect 30: The method of any of aspects 19 through 29, further comprising: receiving control signaling indicating a recommendation for the one or more polarization parameters, wherein the second control message indicating the one or more polarization parameters is based on the recommendation.

Aspect 31: The method of aspect 30, wherein the control signaling indicates a first set of time resources, a second set of frequency resources, or a third set of spatial resources, for the recommendation for the one or more polarization parameters.

Aspect 32: The method of any of aspects 19 through 31, wherein transmitting the second control message comprises: transmitting the second control message via a downlink control information message.

Aspect 33: The method of any of aspects 19 through 32, wherein transmitting the second control message comprises: transmitting the second control message via a medium access control message or a radio resource control message.

Aspect 34: A method for wireless communications at a repeater device, comprising: measuring one or more channels at the repeater device based on a plurality of polarizations of a plurality of antenna panels at the repeater device to produce measurement information; selecting one or more polarization parameters for relaying signaling to a network node based on polarization measurement information, wherein the measurement information includes the polarization measurement information; and relaying the signaling to the network node based on the one or more polarization parameters.

Aspect 35: The method of aspect 34, wherein selecting the one or more polarization parameters comprises: selecting a first polarization for receiving the signaling and a second polarization for transmitting the signaling.

Aspect 36: The method of aspect 35, wherein relaying the signaling comprises: receiving the signaling using the first polarization based on the one or more polarization parameters; and transmitting, to the network node, the signaling using the second polarization based on the one or more polarization parameters.

Aspect 37: The method of any of aspects 34 through 36, wherein selecting the one or more polarization parameters comprises: selecting a first polarization for a first direction of the signaling and a second polarization for a second direction of the signaling.

Aspect 38: The method of aspect 37, wherein relaying the signaling further comprises: relaying a first message in the first direction using the first polarization based on the one or more polarization parameters; and relaying a second message in the second direction using the second polarization based on the one or more polarization parameters.

Aspect 39: The method of any of aspects 34 through 38, wherein selecting the one or more polarization parameters comprises: selecting the one or more polarization parameters based on the polarization measurement information satisfying a threshold.

Aspect 40: The method of aspect 39, wherein the polarization measurement information includes an echo interference measurement at the repeater device based on transmission at the repeater device, the echo interference measurement is based on time division duplexed relaying or bidirectional relaying.

Aspect 41: The method of any of aspects 39 through 40, wherein the polarization measurement information includes a wireless backhaul channel measurement of a wireless backhaul channel with a network node for each polarization of the plurality of polarizations.

Aspect 42: The method of any of aspects 39 through 41, wherein the polarization measurement information includes a wireless access channel measurement of a wireless access channel with a network entity or a UE for each polarization of the plurality of polarizations.

Aspect 43: The method of any of aspects 39 through 42, further comprising: receiving, from a control entity, a control message indicating the threshold.

Aspect 44: The method of any of aspects 34 through 43, wherein selecting the one or more polarization parameters comprises: selecting the one or more polarization parameters for a set of resources enabled for autonomous polarization selection.

Aspect 45: The method of aspect 44, further comprising: receiving, from a control entity, a control message indicating the set of resources enabled for autonomous polarization selection.

Aspect 46: The method of any of aspects 34 through 45, wherein selecting the one or more polarization parameters comprises: selecting the one or more polarization parameters from a plurality of sets of polarization parameters supported for autonomous polarization selection.

Aspect 47: The method of aspect 46, further comprising: receiving, from a control entity, a control message indicating the plurality of sets of polarization parameters supported for autonomous polarization selection.

Aspect 48: The method of any of aspects 34 through 47, further comprising: transmitting, to the network node, a control message indicating the one or more polarization parameters.

Aspect 49: A repeater device for wireless communications, comprising a memory; and at least one processor coupled to the memory, wherein the at least one processor is configured to perform a method of any of aspects 1 through 18.

Aspect 50: An apparatus for wireless communications at a repeater device, comprising at least one means for performing a method of any of aspects 1 through 18.

Aspect 51: A non-transitory computer-readable medium having code for wireless communications stored thereon that, when executed by a repeater device, causes the repeater device to perform a method of any of aspects 1 through 18.

Aspect 52: A first network node for wireless communications, comprising a memory; and at least one processor coupled to the memory, wherein the at least one processor is configured to perform a method of any of aspects 19 through 33.

Aspect 53: An apparatus for wireless communications at a first network node, comprising at least one means for performing a method of any of aspects 19 through 33.

Aspect 54: A non-transitory computer-readable medium having code for wireless communications stored thereon that, when executed by a first network node, causes the first network node to perform a method of any of aspects 19 through 33.

Aspect 55: A repeater device for wireless communications, comprising a memory; and at least one processor coupled to the memory, wherein the at least one processor is configured to perform a method of any of aspects 34 through 48.

Aspect 56: An apparatus for wireless communications at a repeater device, comprising at least one means for performing a method of any of aspects 34 through 48.

Aspect 57: A non-transitory computer-readable medium having code for wireless communications stored thereon that, when executed by a repeater device, causes the repeater device to perform a method of any of aspects 34 through 48.

The methods described herein describe possible implementations, and that the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described aspects.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the aspects and designs described herein but is to be accorded the broadest scope consistent with the principles and novel features disclosed herein.

What is claimed is:

1. A repeater device for wireless communications, comprising:
a memory; and
at least one processor coupled to the memory, wherein the at least one processor is configured to:
transmit, to a first network node, a first control message indicating capability information indicative of one or more capabilities of the repeater device and polarization measurement information at the repeater device;
receive, from the first network node, a second control message indicating one or more polarization parameters based on the capability information and the polarization measurement information; and
relay signaling to a second network node based on the one or more polarization parameters.

2. The repeater device of claim 1, wherein the one or more polarization parameters indicate a first polarization for receiving the signaling and a second polarization for transmitting the signaling.

3. The repeater device of claim 2, wherein, to relay the signaling, the at least one processor is configured to:
receive the signaling using the first polarization based on the second control message; and
transmit, to the second network node, the signaling using the second polarization based on the second control message.

4. The repeater device of claim 1, wherein the one or more polarization parameters indicate a first polarization for a first direction and a second polarization for a second direction.

5. The repeater device of claim 4, wherein, to relay the signaling, the at least one processor is configured to:
receive a first message in the first direction using the first polarization;
transmit the first message in the first direction to the second network node using the first polarization;
receive a second message from the second network node in the second direction using the second polarization; and
transmit the second message in the second direction using the second polarization.

6. The repeater device of claim 1, wherein the one or more polarization parameters include a first set of polarization parameters for a first set of time and frequency resources and a second set of polarization parameters for a second set of time and frequency resources.

7. The repeater device of claim 6, wherein the first set of time and frequency resources includes a first passband, a first subband, or a first set of resource blocks, and the second set of time and frequency resources includes a second passband, a second subband, or a second set of resource blocks.

8. The repeater device of claim 1, wherein the one or more polarization parameters include a first set of polarization parameters for a first set of spatial beams and a second set of polarization parameters for a second set of spatial beams.

9. The repeater device of claim 1, wherein the second control message indicates a set of power parameters for relaying the signaling, wherein, to relay the signaling, the at least one processor is configured to:
relay the signaling based on the set of power parameters.

10. The repeater device of claim 1, wherein the at least one processor is configured to:
measure an echo interference at the repeater device based on transmission at the repeater device, wherein the first control message includes a first echo interference measurement for time division duplexed relaying or second echo interference measurement for bidirectional relaying.

11. The repeater device of claim 1, wherein the at least one processor is configured to:
measure a wireless backhaul channel using each polarization of a plurality of polarizations at the repeater device to produce a wireless backhaul channel measurement, wherein the polarization measurement information includes the wireless backhaul channel measurement.

12. The repeater device of claim 1, wherein the at least one processor is configured to:
measure a wireless access channel using each polarization of a plurality of polarizations at the repeater device to produce a wireless access channel measurement, wherein the polarization measurement information includes the wireless access channel measurement.

13. The repeater device of claim 1, wherein the capability information includes information indicative of a first capability of the repeater device to use a first polarization for transmission and a second polarization for reception, or a second capability of the repeater device to use the first polarization for relaying the signaling in a first direction and the second polarization for relaying the signaling in a second direction.

14. The repeater device of claim 1, wherein the at least one processor is configured to:
transmit an indication of a recommendation for the one or more polarization parameters, wherein the second control message indicating the one or more polarization parameters is based on the recommendation.

15. The repeater device of claim 14, wherein the control signaling indicates a first set of time resources, a second set of frequency resources, or a third set of spatial resources, for the recommendation for the one or more polarization parameters.

16. The repeater device of claim 1, wherein, to receive the second control message, the at least one processor is configured to:
receive the second control message via a downlink control information message.

17. The repeater device of claim 1, wherein, to receive the second control message, the at least one processor is configured to:
receive the second control message via a medium access control message or a radio resource control message.

18. The repeater device of claim 1, wherein the first network node is a first user equipment (UE) or a first network entity, and the second network node is a second UE or a second network entity.

19. A first network node for wireless communications, comprising:
a memory; and
at least one processor coupled to the memory, wherein the at least one processor is configured to:
receive, from a repeater device, a first control message indicating a capability information indicative of one or more capabilities of the repeater device and polarization measurement information at the repeater device; and
transmit, to the repeater device, a second control message indicating one or more polarization parameters for the repeater device to relay signaling to a second network node based on the capability information and the polarization measurement information.

20. The first network node of claim 19, wherein the one or more polarization parameters indicate a first polarization for the repeater device to receive the signaling and a second polarization for the repeater device to transmit the signaling.

21. The first network node of claim 19, wherein the one or more polarization parameters indicate a first polarization for a first direction and a second polarization for a second direction.

22. The first network node of claim 19, wherein the one or more polarization parameters include a first set of polarization parameters for a first set of time and frequency resources and a second set of polarization parameters for a second set of time and frequency resources.

23. The first network node of claim 22, wherein the first set of time and frequency resources includes a first passband, a first subband, or a first set of resource blocks, and the second set of time and frequency resources includes a second passband, a second subband, or a second set of resource blocks.

24. The first network node of claim 19, wherein the one or more polarization parameters include a first set of polarization parameters for a first set of spatial beams and a second set of polarization parameters for a second set of spatial beams.

25. The first network node of claim 19, wherein the second control message indicates a set of power parameters for the repeater device to relay the signaling.

26. The first network node of claim 19, wherein the polarization measurement information indicates an echo interference at the repeater device, wherein the polarization measurement information includes a first echo interference measurement for time division duplexed relaying or a second echo interference measurement for bidirectional relaying.

27. The first network node of claim 19, wherein the polarization measurement information indicates a wireless backhaul channel measurement for each polarization of a plurality of polarizations at the repeater device.

28. The first network node of claim 19, wherein the polarization measurement information indicates a wireless access channel measurement for each polarization of a plurality of polarizations at the repeater device.

29. A method for wireless communications at a repeater device, comprising:
transmitting, to a first network node, a first control message indicating capability information indicative of one or more capabilities of the repeater device and polarization measurement information at the repeater device;
receiving, from the first network node, a second control message indicating one or more polarization parameters based on the capability information and the polarization measurement information; and
relaying signaling to a second network node based on the one or more polarization parameters.

30. A method for wireless communications at a first network node, comprising:
receiving, from a repeater device, a first control message indicating a capability information indicative of one or more capabilities of the repeater device and polarization measurement information at the repeater device; and
transmitting, to the repeater device, a second control message indicating one or more polarization parameters for the repeater device to relay signaling to a second network node based on the capability information and the polarization measurement information.
